(19) United States
(12) Patent Application Publication
(10) Pub. No.: US 2008/0177782 A1
(43) Pub. Date: Jul. 24, 2008

(54) METHOD AND SYSTEM FOR FACILITATING THE PRODUCTION OF DOCUMENTS

(75) Inventors: Timothy Poston, Bangalore (IN); Tomer Shalit, Holmsund (SE); Mark Dixon, Skarholmen (SE)

Correspondence Address: ALBIHNS STOCKHOLM AB, BOX 5581, LINNEGATAN 2, SE-114 85 STOCKHOLM; SWEDENn, STOCKHOLM, omitted

(73) Assignee: PADO METAWARE AB, Holmsund (SE)

(21) Appl. No.: 11/971,220

(22) Filed: Jan. 9, 2008

Related U.S. Application Data
(60) Provisional application No. 60/884,230, filed on Jan. 10, 2007.

(51) Int. Cl. G06F 17/30

(52) U.S. Cl. 707/102; 707/E17.005

(57) ABSTRACT

Comparison of versions of a document reveals both their descent tree and the details of their differences. The descent tree directs the attention of a collaborative author to particular versions and permits leaving the rest in an archive, while appropriate display of the detailed differences simplifies the multi-source editing process. In our preferred embodiment, this is delivered as a web-based service.

### BACKGROUND OF THE INVENTION

Success has many fathers, and so does the modern document: many, scattered authors write it, between them. No tool is truly good at supporting such work. Today's software has all evolved from a weak single-user approach. Over decades, for most users ‘Track Changes’ (introduced by Microsoft in Word98) has been the only noticeable advance. This works well for a pair of writers, who exchange successive versions of a single copy, rarely keeping more than one open. A moved sentence or paragraph or section hides any rewriting within it—the whole block of text is all marked as ‘changed’—but there is no collation problem.

When a larger group of authors work on changes, versions always proliferate. A common strategy is to plan that the draft goes from group member Anne to member Bill to Connie, . . . , in sequence, each making changes. ‘Track Changes’ supports this model to the extent of showing each contributor's changes in a different color, and lets a change be accepted or rejected (by whomever has the document open: there is no ‘authority to accept/reject’privilege for the prime editor). A unique physical document, going from desk to desk to desk, would—and in pre-digital days, often did—enforce this workflow, at the expense of putting every author on the critical path. Any absence or overload for member Dave delays Estelle, Fred, and so on to the end of this drafting round, and to the final appearance of the document. This is far too slow for modern conditions, and also prevents parallel work by members from different disciplines. (A CTO and CFO may both need to see an entire document, as may a physician and a social worker, but they make changes in largely disjoint sections.)

In a digital world this model is unacceptable, unenforceable and unaccepted. Busy collaborator Dave gets to the document when a timeslot opens, passes it on, . . . and soon afterward, thinks of new additions or changes. Since Dave still has a soft copy of what went off, he edits the new thoughts into it without waiting for the next editing round, and mails it (to Estelle, to the main editor, or to the whole group). The new version has changes that are missing from what has now been seen by Estelle and by Fred, and lacks changes that Estelle and Fred have since made. There is no longer a unitary, evolving document. Soon there is a plethora of versions. Collating and merging them into a final document (or a single start-of-next-round document) becomes a painful, laborious task, with many opportunities to miss useful changes or to offend a member who sees the same typo over and over again, and corrects it each time. ‘Track Changes’ simply cannot handle this multiplicity.

Even where members work in the same building, it is hard to schedule a meeting for three or more people to harmonize versions, with line by line discussion. Today's groups are scattered up to twenty-three time zones apart, and a time convenient to all is even harder to find.

We note that Microsoft Word does have a ‘compare and merge documents’ tool. Suppose a document contains the sentence “The best method on the market today is a catheter,” amended by one author to “The best method on the market today is a catheter, which sucks” (which is indeed among the things that catheters do) while another has given “The best method on the market today is a catheter, which does not directly assess volume”. Then, merging the first with the original and then merging the second yields “The best method on the market today is a catheter, which sucksdoes not directly assess volume”. A more usable and structured approach is sorely needed.

A more acute version of the harmonization problem arises where the ‘text’ is a computer program, with different members working on different modules. Minor inconsistencies among assumptions applied to different sections can easily crash the entire application, or even prevent it from compiling. This has led to an industry of ‘version control’ software such as (sampling those running under Windows) Visual SourceSafe, ClearCase, abCVS, CWPerforce and Alienbrain. Some programmers can fit themselves into the discipline of using one of these, since they appreciate the logic and learn its elaborate procedures for detailed control. Many more programmers fail the discipline, or resist it. Few non-programmers can even understand the rules.

FIG. 1 shows a common scenario of current co-authorship in practice, with a time-line from left to right. One author creates a first draft 100, and sends it around to the other people whose name will be on the document. Two of these people begin work on it, and circulate their versions 101 and 102. Another author (perhaps the creator of version 101, perhaps a fourth contributor) reads these versions and absorbs those of their changes she likes into a new file 104, with her own additions and deletions. Meanwhile, yet another author has created file 103 from the original file 100, with some changes that are the same (for example, every author is likely to change “growths misalignments” [a real example] into “gross misalignments”), and with other changes that are not in files 101, 102 or 104. Some other author—who has already contributed, or has not—simultaneously uses 101, 102 and 103 to create file 105. Two distinct authors then use 104 and 105 independently, to create distinct conflations 106 and 107, with—once again—their own distinct additions.

This is the natural work flow that multiple collaborators fall into. It is not easy to impose change on it. Nor is successfully imposed discipline necessarily a good thing for the text. Co-authors need to work in the times available to them, with the materials available to them up to that point. “Checking out” a document, with a locking arrangement so that nobody else can change it until it is “checked in” again, blocks the authors from parallel use of time. Checking parts in and out separately allows some parallel effort, but incompletely so, with a troublesome interface and serious annoyance to users. (You may need to cross-check with a statement in another section, even one that is not your responsibility to edit, so you need at least “read” access. If you spot an obvious typo while reading a write-locked section, you must make a note or send a message to the person who has it open, or something else equally tedious.)

It is better, particularly in an unstructured setting, to support the natural process than to attempt to supplant it. The natural process does have its difficulties:

The creators of 101, 102 and 103 simply worked on the single document on hand when they started; the creator of 104 knew (how?) that 100 could be ignored, and missed the appearance of 103 after he started work; 105 likewise took 100 as superseded, but used 101, 102 and 103 (104 coming too late); then 105 and 106 correctly ignored anything before 104 and 105. Problems arise:
a) How do authors know which files to use or to ignore? (How obvious is it—seeing only a folder of files—that only 106 and 107 need be considered next?)
b) How do authors find the differences between the versions they are using?
c) If a paragraph has moved, how do they find changes within that paragraph?
d) How do they make sure that no proposed change is inadvertently skipped?
e) How do they check whether their own proposals have been ignored?
f) How do they transfer changed text from one version to another?

Problem (a) is answered partly by users looking back over e-mails, and asking other authors: this is a poor solution, and progressively harder as the collection of versions grows. Problems (b-e) require ‘eyeballing’ the texts, and often spreading out hard copy on a real desk-top (not stacking narrow window viewports on the small display area of a typical computer). Problem (f) usually requires ‘cut and paste’, and is error-prone. Grappling with a piece of 12-point text in the Arial font copied into an 11-point Times-Roman paragraph and appearing as 10-point Garamond (a font present in neither file), one may easily be too busy compensating for a word processor's bugs to detect one's own mistakes.

The purpose of the present invention is to simplify the answers to problems (a-f).

### BRIEF DESCRIPTION OF THE INVENTION

The general objective of the present invention is to enable collaborating authors to make use of the multiple versions they create between them, without adhering to a rigid scheme of version control or missing any suggested change by mistake, but assisted in harmonising different revisions. This is achieved by making the software (not the users) responsible for determining which revision has taken which into account, by comparison of version content rather than by a record-keeping protocol to which users must adhere.

In an embodiment of the present invention the method assembles versions of a document or group of related documents, typically from multiple creators, decides by string comparison algorithms and version date (rather than a record of changes) which version takes account of which other versions, and to present to the creator of a new version those differences which that creator needs to know about.

If the creator has saved or uploaded a version which contains segments originating in an earlier version, the creator is presumed to have seen the said earlier version or a version derived therefrom, and thus not to need to revisit it. The first version to repeat such a segment is considered to have direct descent from the originating version, and the directed graph whose edges are formed by direct descent relations is the descent tree of the versions.

In a father embodiment of the present invention the method shows to the user which versions are judged to be relevant to that user, by distinguishing them visually from the others in the assembly. This may be achieved by a different coloration of the identifiers of the said versions or of their background, or by a different typographical format, size or font, by the visible difference of leaves in a displayed descent tree, by presenting them in a separate list, or by numerous other means that will be evident to one skilled in the art.

In a further embodiment of the present invention the method judges which versions are relevant to that user by identifying the leaves on the descent tree.

In a further embodiment of the present invention the method permits the user to modify the set of versions considered relevant to that user by adding or excluding individual versions, in our preferred embodiment by clicking on their representations in the display.

In a further embodiment of the present invention the method optionally includes among the group of versions relevant to that user a Working Copy, which may be the version file most recently created by the user, or the oldest file in the group, or the most recent version issued as a draft by a designated Moderator, or selected by the user.

In a further embodiment of the present invention the method provides a group of one or more collaborators with web access to the assembled versions, such access to include the ability to add versions and supplementary material to the assembly, to download or open files or sets of files in the assembly.

In a further embodiment of the present invention the method enables a user who has opened one or more files in the assembly to edit said files using tools provided by the embodiment of the invention, and to save the results as new versions without overwriting the earlier versions or inventing new file names.

In a further embodiment of the present invention the method enables a user who has downloaded one or more files from the assembly to edit said files using editing software provided by or external to the embodiment of the invention, and to upload the results as new versions without overwriting the earlier versions or inventing new file names.

In a further embodiment of the present invention the method enables a user to upload or download a file or set of files between the assembly and a local file system, by a ‘drag and drop’ operation.

In a further embodiment of the present invention the method displays to the user the differences found by string comparison.

In a further embodiment of the present invention, where the user opens the files over the web, the method presents the said files as an integrated display that shows the differences found by string comparison.

In a further embodiment of the present invention the method may show the said integrated display by using a separate window to represent each version shown, with lines and other graphical devices marking their relationships.

In a further and preferred embodiment of the present invention the method may alternatively show use a single window to represent all the versions shown, without multiple display of identical text.

In a further embodiment of the present invention the method displays substantial repetitions detected by string comparison within a file.

In a further embodiment of the present invention the method uses variable compression of the text to show differences or repetitions in context.

In a further embodiment of the present invention the method enables the said variable compression of the text to be modifiable by user input.

In a further embodiment of the present invention the method enables the user to select among the variant readings offered by different versions, by clicking on elements of the display, and to edit the text directly, so creating a new version.

In a further embodiment of the present invention the method displays to the user each instance of repetition revealed by string comparison, so that the user may select which copy or copies of a repeated segment are to be retained and which deleted, or to mark the repetition as permanently accepted (in which case it will not be presented again to that user).

In a further embodiment of the present invention the method enables one of the group of collaborators to be designated as Moderator, with authority to issue as a numbered draft a version that supersedes all those previous to it.

In a further embodiment of the present invention the method displays the acceptance or rejection by other co-authors or the Moderator of changes made by a user in that user's immediately previously submitted version, or in all that user's previously submitted versions, together with reasons given in comments for such acceptance or rejection.

In a further embodiment of the present invention the method displays the history of adoption or rejection of all a particular user's changes, optionally including attention drawn to the rejection of repeated or near-repeated changes, over the full descent of the document.

In a further embodiment of the present invention the method enables either any member of the group of collaborators, or the Moderator alone, to invite other persons to join the group, such invitation being honored by the embodiment of the invention.

### BRIEF DESCRIPTION OF THE DRAWINGS

FIG. 1: A descent tree of multi-author edited versions in the typical natural workflow.

FIG. 2: Reconstruction of a descent step.

FIG. 3: A sample text for within-file string comparison.

FIG. 4: The partial match between two substrings from FIG. 3.

FIG. 5: The difference of introduction between two texts viewed in windows.

FIG. 6: The difference of deletion between two texts viewed in windows.

FIG. 7: A text window amid others showing partially matched text, with differences.

FIG. 8: A text window amid eight others displaying sections of partially matched text.

FIG. 9: Comparison of two non-uniformly compressed file displays.

FIG. 10: A near-repetition marked in one text window.

FIG. 11: A near-repetition marked in two text windows.

FIG. 12: A repetition marked in a non-uniformly compressed file display.

FIG. 13: A base document and three revised versions.

FIG. 14: A base document with widgets leading to extant revisions.

FIG. 15: The results of three distinct different widget actions from FIG. 14.

FIG. 16: The results of two successive widget actions starting from FIG. 14.

FIG. 17: The result of accepting a transposition marked in FIG. 14.

FIG. 18: The result of accepting a rewrite marked in FIG. 17.

FIG. 19: Changes shown within one non-uniformly compressed file display.

FIG. 20: Changes shown within a compressed file display using ellipse marks.

FIG. 21: A heavily moderated co-authoring workflow.

FIG. 22: A lightly moderated co-authoring workflow.

FIG. 23: Marking a comment target.

FIG. 24: A comment dialogue.

FIG. 25: A folder with many versions of a file, not using the present invention.

FIG. 26: A web folder displaying file version descent.

FIG. 27: A method flow chart according to an embodiment

### DETAILED DESCRIPTION OF THE INVENTION

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The present invention is described below with reference to block diagrams and/or flowchart illustrations of methods, apparatus (systems) and/or computer program products according to embodiments of the invention. It is understood that several blocks of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

### Change Tracking Versus Document Comparison

The history of changes becomes arbitrarily complicated as soon as more than two authors/editors are involved. A record made of what a user does can catch only a binary change, between the previous and new versions on this user's computer. It is complex to reconstruct from a collection of such records the differences between all current versions, with the (potentially competing) mergers that feed several ancestors into one, and the (potentially competing) revisions that make several versions out of one. Even gathering together such change records into a history network would normally require that they be made in a standardised format, forcing the authors to use shared software that not only records the changes, but connects the versions by a unitary system of ID markers.

Further, if a user changes version V₁ by importing a paragraph from version V₂ (thus creating V₃ or higher), at the text level the obvious change to record from V₁ is just that a paragraph P has been inserted. The ‘cut and paste’ mechanism supported by most operating systems, which copies a section into a buffer and then into another file, does not support even recording a record of an ID for the source document. Much less does it support transferring change records associated with P, recording modifications which another user made from the form of the same paragraph in an earlier version V₀. A third user looking at the modified version of V₁ thus does not know of these differences, and must refer back to V₀ and V₂ to find them. To change this requires the use of a common change-mark-up scheme across all documents, and a ‘cut and paste’ mechanism that preserves these marks, as the Windows mechanism attempts with imperfect success to do for format marks (bold, italic, color, font, size, etc.). If a group includes users with Windows, MacOS and Linux machines, with widely-used editing software such as MSWord, emacs, OpenOffice and PDF Writer, such a common framework is unavailable.

Such a framework may be enforced within one corporation, but when (for instance) the document is a contract involving two or more companies, and a law firm for each company, no writer wants to change habitual editing software for a single document. A multi-writer solution using change records would require global office software hegemony to even start. It would tend to lead to rigid tools, hard to modify with user feedback, and a user interface (UI) that aims more to display changes as actions than as results. (In Word, a change from “The brown quick fox” to “The quick brown fox” can be made in two ways—drag “brown” to the right, or drag “quick” to the left—and is displayed as “The brown quick brown fox” or “The quick brown quick fox” accordingly, though the final result is identical, and though the visual difference is irrelevant to the next user. This clumsiness is not logically forced by change tracking, but in programming practice as in geopolitics, means do shape ends.)

In contrast, then, the present invention exploits direct comparison between all documents submitted to the system as part of the same project. In our preferred embodiment this system runs over a web-style network (either the open ‘world wide web’, or an intranet), with files transferred between individual computers. We describe it primarily in these terms, but it will be evident to one skilled in the art that simple modifications would enable it to operate—for example—on a central ‘main frame’ computer which retains files, and which all users log into when they wish to modify a file. Other modifications would enable it to operate on the computer used by one member of the group, with email attachment of files rather than web sharing.

Certain applications of the invention, detailed below, are helpful even to a single user independently of any group, and a version supporting these could be implemented as a stand-alone application on an unconnected computer.

Recent decades have brought fast algorithms for string comparison, notably aimed at DNA sequences, as in S Needleman and C Wunsch, A general method applicable to the search for similarities in the amino acid sequence of two proteins, J. Molec. Biol. 48(3): 443-53 (1970), and the variant of their algorithm described by T F Smith and M S Waterman, Identification of Common Molecular Subsequences, J. Molec. Biol., 147:195-197 (1981), which is more sensitive to local alignment without requiring a global match. (In both chromosomes and text, long sections may be transposed, during evolution and editing respectively.)

Such algorithms, and work on running them faster such as A Wozniak, Using video-oriented instructions to speed up sequence comparison, Comput. Appl. Biosci. 13(2):145-50, 1997, S Kurtz, A Phillippy, A L Delcher, M Smoot, M Shumway, C Antonescu, and S L Salzberg, Versatile and open software for comparing large genomes, Genome Biology (2004), Genome Biol., R12.1-R12.9, A L Delcher, A Phillippy, J Carlton, and S L Salzberg, Fast Algorithms for Large-scale Genome Alignment and Comparison, Nucleic Acids Research 30, 11 2478-2483 (2002), and A L Delcher, S Kasif, R D Fleischmann, J Peterson, O White, and S L Salzberg, Alignment of Whole Genomes, Nucleic Acids Research, 27:11 (1999), 2369-2376, make it practical to process any pair of sequences and find both shared parts, and differences within those parts. It is now common to test a gene against a large body of DNA data, to find genes that are approximately the same, or approximately share subsequences at practical speeds: for example (see http://mummer.sourceforge.net/), one can find all 20-basepair or longer exact matches between a pair of 5-megabase genomes in 13.7 seconds, using 78 MB of memory, on a 2.4 GHz Linux desktop computer. The text in a typical collaborative document contains considerably fewer data—about a megabyte per 500 double-spaced pages—so that full text comparison of versions is highly practicable. (A document is often a multi-MB file, but in these cases most of the size is due to embedded images. The present invention does not seek to compare images, but including their names and sizes in the comparison process can detect many changes in illustration as well as in text.)

There are many analogies between text matching and DNA matching. For example, chromosomes have many stretches called ‘junk DNA’ because they do not code for amino acid sequences in proteins (the sequence for one protein has come to be called ‘one gene’, so junk DNA is not in genes). Some of this may control the elaborate, multi-level way in which DNA coils, and the 3D chromosomal structure which enables the cell access to any gene that its dynamic wishes to express: if so, it is more like XML mark-up than ‘junk’. However, from the direct content point of view it includes long sequences of identical repetitions, with easily mutating lengths. For protein comparison purposes one wishes to ignore these length differences, and the algorithms used allow for this. The analogy here is with whitespace, whose length often changes by cut and paste, by different prejudices of writers (some insist on a double space between sentences) or different software. (L_{A}T_{E}X treats any whitespace sequence, including at most one new-line, as one whitespace token. Software that saves a L_{A}T_{E}X file may write whitespace sequences quite different from those it read, without creating a content or format difference of interest to the user.) The molecular biology matching rules that ignore differences in the length of repeat sequences adapt directly, for one skilled in the art, to text matching rules that ignore differences within whitespace.

In the final version, published or distributed, of a document, white space details make a difference to the look. But a group of co-authors will usually do a less good job of adjusting those details to a neat, homogeneous look than any one co-author would do alone, and concentration on content over layout in the collaborative stages will make them more productive. Our preferred embodiment, therefore, suppresses differences of whitespace length, vertical gap height between paragraphs, etc., when comparing drafts.

FIG. 4, discussed below, diagrams the coding of differences and matchings at the level of a pair of sentences, considered as strings of characters; such coding is familiar to those skilled in the art of genetic matching algorithms. The full content of a typical document file includes, beside such material to be printed or displayed to the user, instructions to change font, begin or end bold face or the current section, and so on, but these elements may be matched in the same way. Our preferred embodiment matches file content across different formats, where line breaks, section breaks, font information, etc., are very variously coded, so it requires translation routines to bring them into a shared representation (which may be an open or a proprietary standard) in which matches and mismatches become clear. The USPTO filing 60/869,733 “A Method and System for Facilitating the Examination of Documents” by the same inventors, which is hereby incorporated by reference, teaches among its other constituents a manner of constructing a hierarchy of sections from typographical data in a document that is structured only visually, rather than with explicit structural mark-up. It is highly desirable to include this capability in any embodiment of the present invention, as well as the said disclosure's mutably compressed view, whose use in the present invention is discussed further below. The data so constructed would in the present invention be encoded in terms of the shared representation discussed above, so that hierarchy as well as string structure can be compared and matched.

An alternative approach to comparison exploits the hierarchical structure of the texts, which almost always includes at least sentences and paragraphs, and often chapters, sections, subsections, etc., at multiple levels. (No such straightforward structure has been identified in chromosomes, though there is a suspicion that some of the ‘junk DNA’ has a somewhat analogous organisational function.) A preliminary comparison can exploit this for efficiency, since for example a sentence or paragraph in file A which perfectly matches a sentence or paragraph in file B must match it, in particular, at the ends. Consequently, a search for perfect matches can discard many candidates quickly, by the failure of agreement at the start or the end, decreasing the time taken to find all the perfect matches. This in many cases means to find a large fraction of the overall matching structure, so that less effort is needed in finding the remaining imperfect matches. However, this is an issue of algorithmic performance, since the overall matching description sought is the same in either case: the core of the present invention is the fact that such a description can be found (and found fast enough to be useful), together with means of exploiting this description. A preferred first embodiment is thus to adapt the highly optimized forms already achieved for the algorithms current in molecular biology, without changes that could sacrifice that optimization. (Analogously, in principle N bytes (octets of 0s and 1s) can be used with less computation than N binary 32-tuples; but with byte data on a 32-bit processor, it is better to expand the bytes to 32-tuples unless the computation can pack them in groups of four and combine the byte arithmetic into recognized 32-bit operations, which requires research and ingenuity. Re-use of optimized resources can out-perform a superior method that is not yet optimized.) We expect later embodiments of the invention to exploit more fully the available structure.

### Comparison in a Cluster of Documents

The invention, then, is of a system which stores a cluster of documents related by history and optionally by interdependence, each in one or optionally more sections. These are handled as distinct versions of one or more files such as ‘business plan’, ‘elevator presentation’ and ‘press release’, and perform comparison, presentation and manipulation operations to be described more fully below. We refer to this cluster as a Work In Progress, or WIP, and to the system provisionally as OmniPad. Before describing the interaction workflow, we disclose the underlying comparison processes. An important goal is to detect document relationships automatically, rather than rely on record-keeping by human users with disparate backgrounds and low motivation for training. It is important to note that a co-author may edit a document within OmniPad, but may also receive a version by download or email attachment, work on it with locally installed software, and return an edited version (called below a ‘proposal’). Since the co-author may receive it as—for example—getHappy.doc and return it as getHappyB.doc, while another may even send back beGlad.doc, file names are insufficient in tracking document identities.

When a new file is entered in the WIP, OmniPad immediately performs string comparison between its content, preferably including but not necessarily limited to
material normally displayed as visible text
mark-up elements like HTML or XML tags that identify headers, paragraphs, etc.

file names and other available data related to embedded images, though not the images themselves
markers with semantic implications, such as italicisation, bold face, underlining, Strike through or superscript, translated as necessary between different mark-up systems
   and the content of other files (if any) already in the WIP, beginning with the most recent version of a file with the same name. If no such file is present, OmniPad compares the file name with the names of the files already present, and selects the name that is most similar to it by one of the measures familiar to those skilled in the art of string comparison. In the ‘moderated mode’ described below there may be an issued draft with the selected name, in which case comparison begins with this file.

We note that not all mark-up systems are fully mutually translatable: for example, equations written in a document using the L_{A}T_{E}X system cannot be well reproduced in the more limited representation available in MSWord, though translators exist (for example) between L_{A}T_{E}X and MathML. However, an interdisciplinary co-author sometimes finds it necessary to recreate a L_{A}T_{E}X document ‘fubar.tex’ as ‘fubar.doc’, for a T_{E}Xnically unequipped collaborator, publisher or patent attorney. Continuity should not be lost to OmniPad for such a reason. The string-matching code in our preferred embodiment therefore tags mathematical sections as a special class of difference, allowing a user to check them visually or for the moment ignore them. This requires recognising that “for a less than 3” in Word (using only italic and font markers) and “for $a$ less than 3” in L_{A}T_{E}X (which explicitly tags mathematics mode with the $ sign) have such a correspondence, as do “for a₁ less than 3” and “for $a_{l}$ less than 3”. An ideal embodiment would spot that “a₁” matches “$a_{—}{1}$” exactly in final effect, that “a¹” matches “$â1$”, and not vice versa: but in our currently preferred embodiment (for reasons of simplicity) it is enough to tag those literal string differences that may arise only as a change of representation. A check on mathematical expressions can be called out as a separate human task.

An important use of comparisons is to model ‘descent’ among files, as in FIG. 1. In that Figure, arrows represented actual history: files used by different authors in making new ones. A hegemonic system could track files a user had simultaneously open, but the present invention seeks to avoid requiring common software that must be installed on all authors' machines or logged into via the web or an intranet. (No log-in may be available, for instance if a busy author is trying to make gainful use of travel time.) We seek to reconstruct the descent structure, from internal evidence.

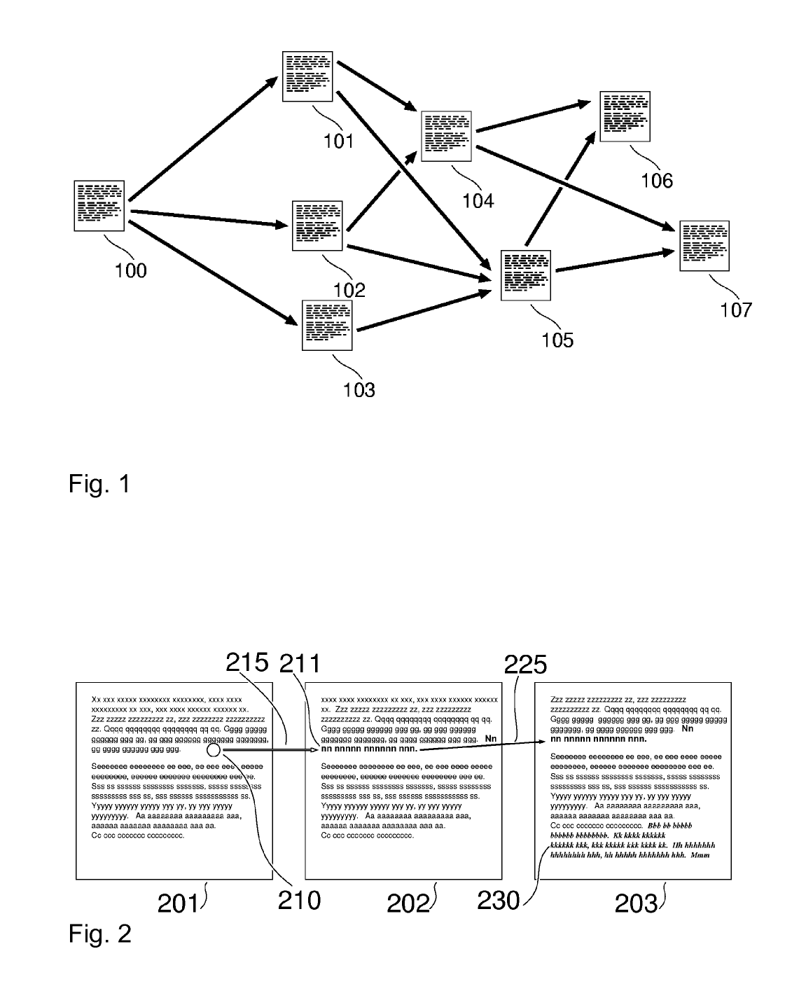

In FIG. 2, string comparison between text version 202 and all earlier-dated versions such as 201 reveals that a sentence 211 drawn as “Nnnn nnnnn nnnnnn nnn” occurs in 202 alone, with a gap such as 210 where it might 215 be found. It is thus a reasonable presumption that the sentence 211 originates in version 202. If version 203 is the first after 202 that does 225 contain the sentence 211 (and perhaps new material 230), this is strong evidence for the version 203 being a ‘direct descendant’ of 202, in that the creator of 203 had 202 available, and open, while creating 203. The creation process itself may have begun with something other than 202 (such as the creator's own copy of 201, or another file), but 202 has been taken into account.

It is harder to tell whether 202 has been fully taken into account, with all changes made there either accepted or rejected. The creator of 203 may for example be interested only in the market analysis part of the evolving document, and ignore completely the engineering section. The collaborators may reduce this problem by breaking the WIP into a cluster of documents, one for each section: optionally an embodiment of the invention may support this, by for example providing for an over-file which lists the parts to be included. This however becomes somewhat format-dependent: L_{A}T_{E}X, for example, contains such a mechanism already, while many widely used commercial formats do not, or—with similar results—most users do not know about it. An implementation of such a mechanism within the present invention would force all co-authors in the group to use the present invention directly if they wish to display or print the fully-assembled document. Since it is desired to allow the present invention to be used only by those members of the group who so choose, rather than hold the group to the e-literacy level of the least sophisticated member, such an over-file should be optional rather than a mandatory tool. Another abatement of this ‘partial use’ problem lies in the ‘My changes’ and Change Log features below.

In a first embodiment, then, version 202 may be labelled as ‘no longer relevant, to those who have seen 203’; in a graph like FIG. 1, we would represent this by an arrow from 202 to 203. We refer to such an arrow as the direct descent of 203 from 202. Stronger tests may be added within the spirit of the present invention.

The use above of a sentence as the unit 211 of evidence for text derivation is purely exemplary, as is the matching of it to a gap 210. One could use a larger or smaller unit, or a sentence which it changes rather than a gap, but it is necessary to set a minimum degree of change. In a recent example of a document edited by one of the present inventors, both he and another author independently changed
“The initial global matches performed to correct growths misalignments”
   to
“The initial global matches are performed to correct gross misalignments”
   before seeing each other's work. Each produced a changed version, each with other edits that the other lacked. It would have been an error to consider either as having taken account of the other; the next version needed to take account of both. Just as in molecular genetics, the occurrence of the same mutation in two specimens does not prove common descent. (Certain mutations, such as the one for albino coloring, occur regularly in many species.) However, molecular biology also provides measures, well known to those skilled in the art, to quantify the degree of difference between two strings. It is thus straightforward to generalise the above special case of “if a sentence occurs in file A, in every earlier file is unmatched or is matched to a gap, and has in B its earliest occurrence after A, then B has direct descent from A,” to “if a substring above a preset length l occurs in file A, fails by at least a difference amount δ to match any string in any earlier file, and has in B its earliest occurrence after A, then B has direct descent from A.” Optionally one could allow the occurrence in B to be slightly changed, but this weakens the conclusion of direct descent. It is more fruitful to strengthen it, for example by requiring the occurrence in B of more than one string that occurs for the first time in A. Many other such variations on this descent test will be evident to one skilled in the art.

We refer to the directed graph whose nodes are versions and whose edges are given by direct descent in the above sense as the descent tree. If a version has no other version with direct descent from it, it is a leaf of the descent tree. (Note that this directed graph is a tree as in the usage ‘family tree’, not necessarily in the graph theoretic sense that disallows multiple paths between a pair of nodes.

A version stored within the control of OmniPad may be stored simply as a sequential file, or space may be saved by storing it as a list of incremental differences from some other version (a difference base), from which it can be reconstructed as needed, by means familiar to those skilled in the art. This is comparable to saving animation frames as a sequence of differences, rather than waste memory on unchanged pixels. It has storage advantages, and also speed, since a difference can be stored faster than a file, permitting essentially continuous back-up, particularly valuable in a web service, such as is intended as a major use of the present invention. The user does not see a list of intermediate file versions, and for space reasons these are not maintained as separately stored files, but each time a unit task is performed a new and potentially accessible version is created. (A unit task may be defined as the uninterrupted insertion/deletion of a word, alternatively of a contiguous string of text, or as any textual change that cannot be more compactly described as a combination of smaller changes.) In conventional editors, for either text or images, such a record is used only to step back globally through the changes: in PhotoShop™ for example, if one selects, paints, and rotates part of an image, each of those states is listed separately in a history palette. One can then select any of the states, and the image as a whole reverts to how it looked when that change was first applied, and new work can be started from there. It is however impossible to restrict such reversion to one or several layers, or image regions. Similarly in Microsoft Word, the Ctrl-Z Undo command steps back through changes, but cannot be limited to a particular paragraph or substring. If “Track-Changes” is turned on, one can move more selectively, but not (for instance) compare an edited-and-then-moved paragraph with its earlier state, without moving it back.

This is an implementation choice and should not be visible to the user, except in its impact on storage needs. As differences accumulate, internally to OmniPad it can become convenient to save a new difference base (for faster reconstruction, using fewer changes), but in our preferred embodiment the saved difference base does not automatically appear as a user-visible version.

To allow a powerful ‘Undo’ system (see below), the list-of-differences method is a strongly preferred embodiment, with a time-stamp on each stored difference.

### Hierarchical Structure

The standard writing conventions of European-language text permit automatic segmentation into sentences. A sentence break is defined by a “.” followed by whitespace followed (if at all) by a capital letter. For this purpose a closing parenthesis or quotation mark must be allowed as the beginning of whitespace, and an opening one as the end of it. With the occurrence of a mathematical symbol at the beginning of a sentence, or of a trade name like “eBay”, an algorithm would require more linguistic sophistication to recognise the same sentences that a human does, but OmniPad can function without this exact agreement. (Linguistic tools that would always correctly identify sentences would also be capable of identifying clauses and other such substructures, leading to variations on the present invention that will be clear to those skilled in the art.) Whitespace and punctuation were largely absent in Roman writing, and in Asian scripts until more recently, but have now spread to most languages. Though many still eschew capitalisation, most have introduced reliable identifiers for sentence breaks. (In some cases, such as Korean writing, this process has included invasion by the separate sentence concept itself, changing accepted prose style.) We thus assume that a usually correct automatic segmentation into sentences is performed by a function within OmniPad.

Ancient Greek manuscripts separated units of text by a horizontal line called a paragraphos (“with/beyond the writing [graphos]”), which gives us the next size unit. This too has invaded many languages. Visual conventions to mark it usually include a new line, often an indent or an outdent, and sometimes extra vertical space. Every digital text file format includes a paragraph-break convention: for example, L_{A}T_{E}X marks them by two successive ‘new line’ characters in the source file (treating single ones as whitespace); MSWord uses a single one, with visible line breaks created dynamically; HTML uses “<p>” to begin a paragraph, and optionally “</p>” to end one. The use of such conventions must be implemented within OmniPad format by format, but the net result is a well defined separation into paragraphs. A paragraph break invariably implies a sentence break.

Above this level, the only clear agreement is that the hierarchy should have a strict tree structure, with no multiple descent. A sentence cannot lie across a paragraph break, a paragraph cannot continue into a new section, a section is within one chapter, which lies in one book, and so on. The actual hierarchy varies between formats (for instance in the depth of section/subsection/subsubsection/ . . . allowed), so that to get the benefit of OmniPad features which refer to hierarchy a group of co-authors must agree on one file format, or on a set of formats whose hierarchy systems are mutually translatable.

### Describing and Displaying Differences

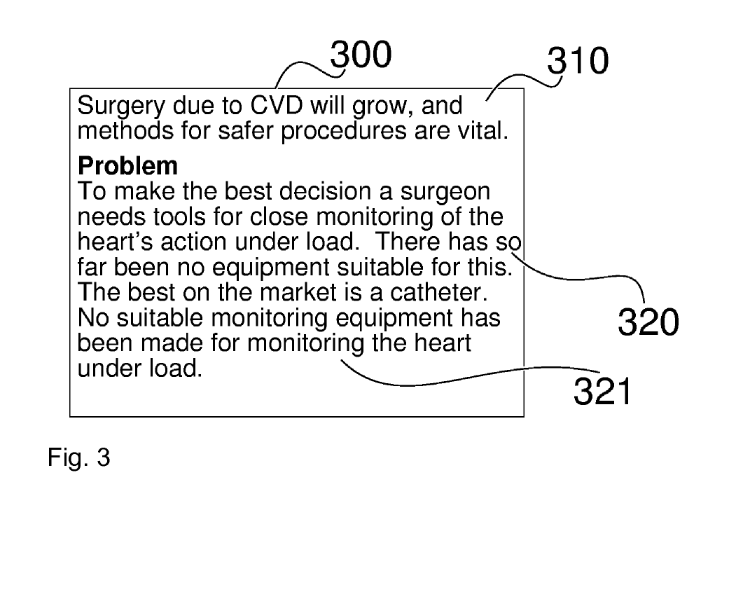

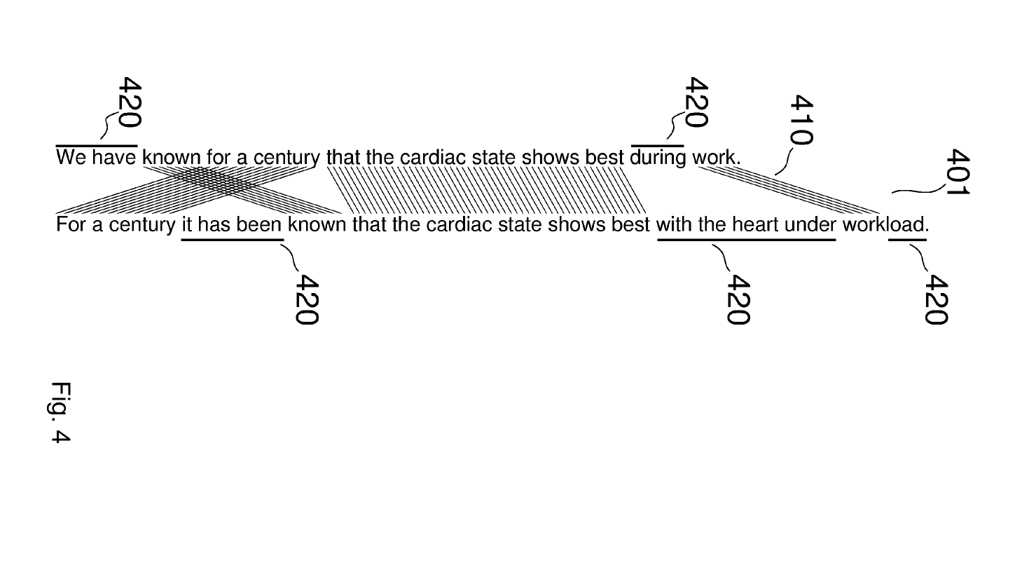

We first discuss the nature of differences between parts of a single file containing text, then between a pair of such, and then those among a group. In each case, one file B is chosen as comparison base: for a single file, only one choice is possible. Single file FIG. 3 shows a window 300 showing part 310 of a draft document propounding a device. (The window has a lower than usual number of words, for clarity of illustration.) This holds a common but insidious error, needing correction. Sentence 320 is extremely similar to sentence 321. When unintended, this often arises from a ‘cut and paste’ error: use a different button, or Ctrl-C instead of Ctrl-X, and you ‘copy and paste’ instead, leaving the original in place. It also arises easily in collaboration, where one author moves a segment of text, and another accepts the resulting insertion but does not notice (or does not see the reason for) the corresponding deletion.

At the separation shown in the window 300, such a repetition is easy to spot, but still harder than a spelling or syntax flaw, as neither paragraph is defective in itself. Reading the text a second time, the undue familiarity of 321 is easily attributed to the previous read-throughs, rather than to the recent sight of 320, so the echo persists. (An echo can be effective prose, but may often give the reader a sense of moving backward, to an earlier point in the writers' case. It should never be unintentional.) As each persists through successive versions, it can accumulate cross-references, “as we said in Para m” or “as discussed on page n”, that unravel if it is removed, and must be detected and changed. It is far better to detect the problem early, before such intricacies build up.

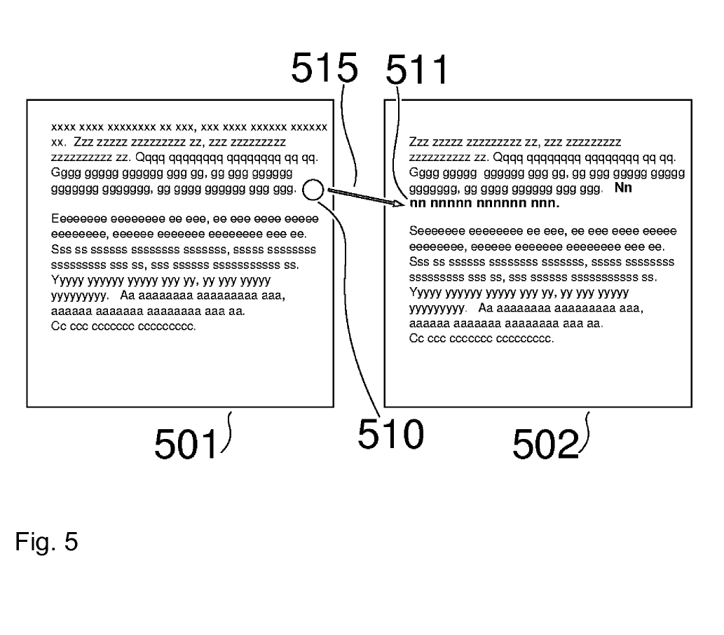

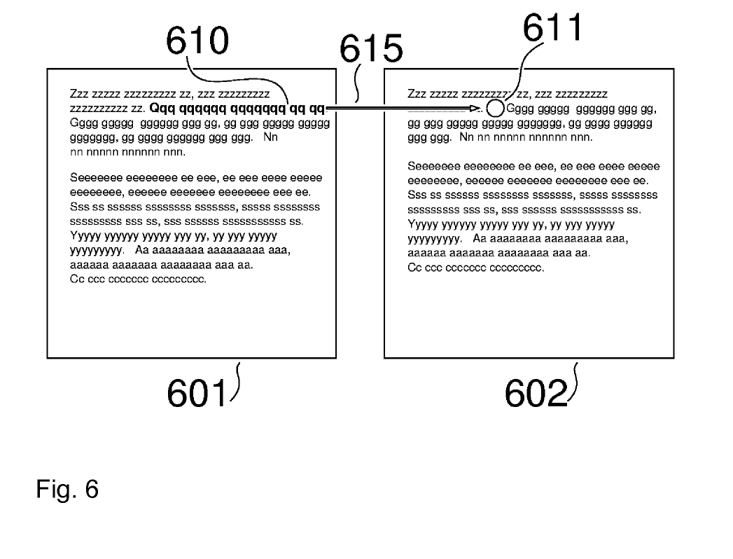

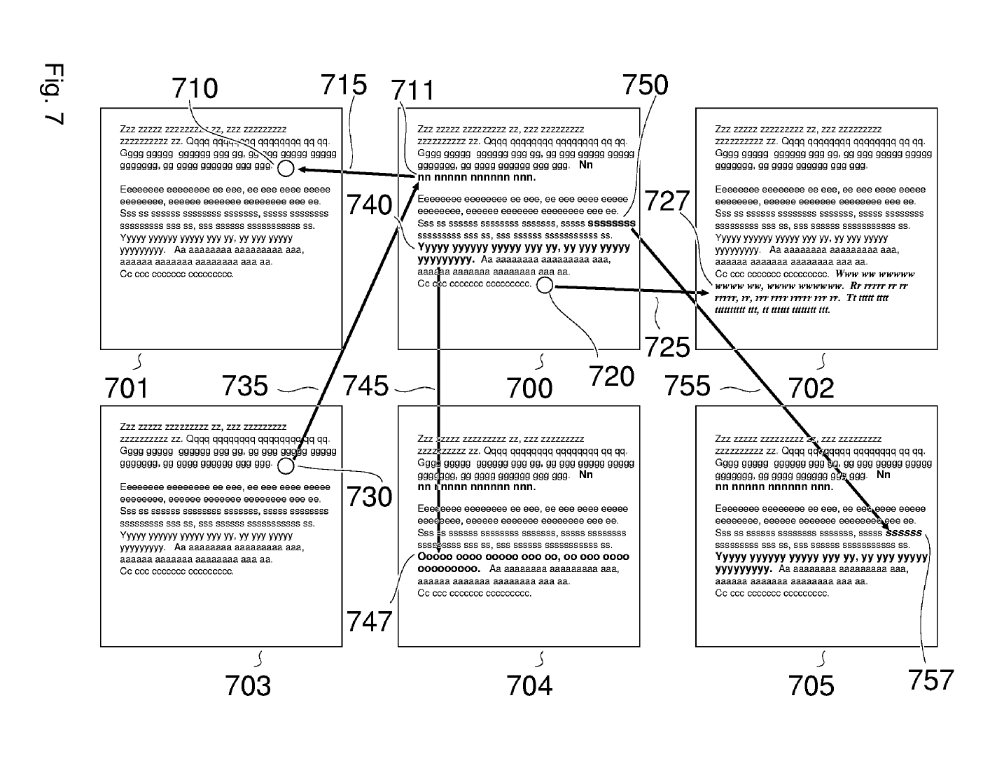

FIG. 4 diagrams such a near-repetition, in the form of the match as recognised by an algorithm such as Smith-Waterman. The slanting lines 410 show the correspondence of substrings, and the vertical lines 420 the gaps to which no part of the other string corresponds. Even with penalties for gaps and interchanges (and optionally for mismatch of upper and lower case letters), any scoring system gives this a far higher match value than chance. A semantic system able to recognise a proximity in sense between “we have known x” and “x has been known” would raise the score yet higher, and its use would be within the spirit of the present invention, but remains too computationally costly for our preferred first embodiment. Pure string-matching algorithms, highly optimised for biochemical work, suffice for our present use. It is important that they both permit, and describe, differences within a matching. We discuss below the presentation of such a repetition to the user. Paired files A file V may differ variously from file B. In the simplest way (FIG. 5) a substring 511 present in a part 502 of the file V is matched 515 to a gap 510 in the matched surroundings 501 in B, or vice versa: FIG. 6 shows a gap 611 in the file V (drawn as 602) that is matched 615 to a substring 610 in B (drawn as 601). We call the case in FIG. 5 a deletion if the substring 511 exists in a matching context in some file from which B has descent (direct or otherwise), or a relic gap if it does not. The case in FIG. 6 is a relic if the substring 610 exists in a matching context in some file from which B has descent (direct or otherwise), or an insertion if it does not. Collectively, these four cases are gapped matches.

A mismatch is a permutation if it substantially matches after interchanging of two neighbouring substrings, such as in the change between “The brown quick fox” and “The quick brown fox”, even if there is also a mismatch of whitespace sizes. (Whitespace is often messy after cut and paste.) A permutation may be of longer strings, for example rephrasing the previous sentence as [A mismatch is a permutation if it substantially matches after interchanging of two neighbouring substrings, even if there is also a mismatch of whitespace sizes, such as in the change between “The brown quick fox” and “The quick brown fox”.]. It may permute whole paragraphs, sections, or other recognised units. If the permuted substrings substantially exist in the descent of B, but do not exist in the descent of V, the mismatch is a relic permutation; otherwise, it is a new permutation.

If a string is moved to a distant location, one could formally treat this as permuting it with the intervening material, but it is more natural to the user to say “this has moved” and highlight it than to say “these have moved” and highlight both. In our preferred embodiment, currently defining “distant” as “more than three times the string's own length”, we therefore call this a transposition of the string. If the move substantially exists in the descent of B, but does not exist in the descent of V, the mismatch is a relic transposition; otherwise, it is a new transposition.

A rewrite is a mismatch which cannot be expressed in terms of gapped matches, transpositions or transposition steps up to a pre-set density. For example, “the quick red fox” could be obtained from “the quick brown fox” by deleting “brown” and inserting “red”, but this is too many steps for one word. Similarly, there are too many such steps in going from the sentence used above to [We call a mismatch a permutation if one string matches the other after swapping two neighbouring substrings, perhaps with a mismatch of whitespace sizes, such as in “The brown quick fox” versus “The quick brown fox”]. A break-down into such steps would produce an unreadable display. For comfortable display, our preferred embodiment sets the allowed density to zero: “brown” versus “red” in matching positions are then displayed in the same style as “plotoprasm” versus “protoplasm”. If the rewrite substantially exists in the descent of B, but does not exist in the descent of V, the mismatch is a relic rewrite; otherwise, it is a new rewrite.

Observe that a permutation or a transposition can contain other differences, such as if we permuted the above two paragraphs while deleting “A break-down into such steps would produce an unreadable display” and changing “we therefore call this a transposition of the string” to “we designate this therefore a transposition of the string.” With too high a level of such differences, however, and without the cue of corresponding position, the matching algorithms will not identify a permutation or a transposition. The result will usually be classified as a rewrite, or a gapped match. Multiple files Suppose there are several files V₁, V₂, . . . beside the reference base. If an identified difference occurs between B and just one of these files, it is a singular difference. If it occurs between B and more than one of them, as in the “growths misalignments” example above, it is an equal difference. If a string in B is matched (but imperfectly so) to imperfectly matched strings in distinct files Vᵢ and Vⱼ, these are conflicting differences.

These characterisations are important in the presentation of differences, addressing in particular problems (b) and (c) listed in the Background of the Invention above.

### User Workflow

A single realisation of OmniPad on a particular machine may in the same manner store multiple WIPs, for different users or the same users, and handle each WIP as here described. No modification of the description below is required, except to set up a process by which a user gains access to the WIP or WIPs for which that user has authorisation, so as to begin work in a chosen WIP. The manner of setting up such a process is well known to those skilled in the art, with the most common being that the user presents a user identity and password. Several alternatives are listed in USPTO filing 60/891,534 “A Method and System for Invitational Recruitment to a Web Site” by the same inventors, hereby incorporated by reference. OmniPad may be operated in at least two modes. Moderated mode gives one identified user certain privileges of final decision. In consensus mode, no individual has overall authority. (Elaborations within the spirit of the present invention whereby one individual has moderator privileges over one section of the document, while another moderates a different section, will be clear to those skilled in the art.)

It is convenient here to introduce some definitions: those applicable to moderated mode, to consensus mode, or to both are marked M, C or MC respectively.

WIP (MC): A Work in Progress, as described above.

Work Group (MC): The set of users who currently have access to a particular WIP.

Document (MC): A WIP contains one or optionally more sections handled as separate document files. Each is given a label that persists through versions: OmniPad treats the document name as an editable aspect of the document, directly comparing to recognise identity of two documents (which thus share a label). Labels propagate, so that if B has enough points of resemblance to A to be classified as a version of A, while C has enough points of resemblance to B to be classified as a version of B, then A and C receive the same label. However, an embodiment may force the creation of a copy with a new label, if for example the users need to create a version rewritten for the South Asian market, without superseding the original for use in North America.

ID (MC): A tag on a document version file that may include the document label, a ‘last-modified’ date and time, the name of the co-author who saved it, in preferred embodiments the name of the WIP it belongs to, and whether it is a moderated mode ‘draft’ (see below).

Modification (MC): OmniPad defines modification separately from the operating system time-stamp (Windows, for example, includes moving an unopened file from one folder to another as ‘modification’, and updates its stamp). Provisionally, a file is marked as modified when it is saved, but OmniPad checks whether differences from a previous version actually exist; if none do, the time-stamp for that version is used. When a collection of documents created outside OmniPad is imported into it as a WIP, if they have pre-existing time-stamps accessible to the import process these are adopted as OmniPad time-stamps. If not, they are all stamped by the time of the collective act that imported them, to avoid spurious distinctions as to which is newer.

Moderator (M): A person in charge of a WIP. There is one moderator per WIP in moderated mode, none in consensus mode.

Co-author (MC): Collaborator on the WIP. There can be multiple co-authors on one WIP. A moderator also functions as a co-author.

Draft (M): A document version sent from the moderator to one, to several or to all co-authors. A draft is given an ID that includes the document label, a ‘last-modified’ date and time, the name of the co-author who saved it, in preferred embodiments the name of the WIP it belongs to, and the fact that it is a moderated mode ‘draft’. In the descent tree, described above, it is automatically given direct descent from all leaves extant at the time of issue, irrespective of internal evidence. The Moderator is assumed to have had all of them open. It thus becomes, temporarily or finally, the sole leaf on the descent tree.

Descent tree (MC): The directed graph whose nodes represent versions and whose edges represent the relation of direct descent.

Recipient list (M): The list of co-authors to whom a draft is sent.

To issue (M): for the Moderator, to send a draft to a co-author, with a version number. By default, when the Moderator issues a draft to any co-author, the Moderator is also on the recipient list. When the Moderator ends a session, or closes a document, by default any changed document is issued as a draft to the Moderator herself. The interface may provide a dialogue at this point by which the Moderator decides whether to add others to the list.

Proposal (M): A new version of a document in the WIP that a co-author passes to the moderator, preferably by saving within OmniPad or via upload to OmniPad, but email, carried CDs, etc, may be allowed, with digital form strongly preferred. (If it is not uploaded to OmniPad, the Moderator must enter it locally. If it is in hard copy, the Moderator must have it typed in. The not-via-OmniPad version is for Moderators with technically confused co-authors, and with time to compensate for them. The Moderator sets policy on these options.) A proposal always receives an ID.

Variant (C): A new version of a document in the WIP that a co-author uploads to OmniPad. A variant always receives an ID.

Moderator's board (M): The ‘light table’ or ‘cutting room’. The interface where the Moderator works and assesses the proposal and accepts or rejects changes. This contains a copy (with a new ID) of the most recent issued draft, and copies of any proposals received since that draft was issued.

Proposal response (M): When a proposal has been worked through in the Moderator's board, a proposal response is sent to the co-author behind the proposal. This log shows which part of the proposal has been adopted and what has not, and any comments by the Moderator on her choices.

Open (MC): A copy of a document is open (or fully open, when the distinction from ‘read-open’ below must be emphasised) to a particular user if that user can make changes in it without a new numbered version becoming visible to other users. This status can persist over separate log-in sessions, but the administrator may set an ‘idle time’ limit. If a copy of a document is open to a user who does not make changes for a time exceeding that limit, the document is closed and a numbered version issued. In moderated mode, this numbered version is treated as a proposal.

Read-open (MC): A version of a document is read-open if its contents are so displayed (in whole or in part) as to allow a user to transfer material from it. A version saved with an ID is not available for change: any future access made using that ID will produce the same content. A user can make a copy fully open, but any version saved from this copy will automatically have a new ID.

Working copy (MC): A version currently open, in which a user is making changes by new typing or by transfer of material from a read-open source. A user may select any version as working copy. In moderated mode the default selection is the most recent draft, unless that user has already created from that draft a newer version, which becomes the default. In consensus mode it is the most recent version created by that user, if any; otherwise, it is the most recent version created by any user.

Changes (MC): When a draft is compared to one or several subsequent proposals there will be differences in the text. These differences are referred to as changes.

Selector Widget (M): The widget used by a co-author in selecting which changes in one or more proposals, and what part of such changes, she wants to adopt.

Adoption (M): When the Moderator uses the Selector Widget to transfer a change from a proposal to the Moderator's working copy.

Assent (MC): When a work group member uses the Selector Widget to transfer a difference from an alternate version to that member's working copy. This includes Adoption, in the case where a moderator exists and is the user.

In either mode, a user acting as administrator sets up a WIP, and identifies other users with access, either by specifying identities from a larger pool such as the employee list of an organisation, or by giving the email addresses of these users, or by such other means as will be evident to one skilled in the art. Each such user is notified (in our preferred embodiment automatically notified), and provided with permissions and passwords as necessary. He or she must be registered with the server that runs the system: our preferred embodiment can pass a WIP invitation to the user by either a ‘to members’ pathway, or (following the method disclosed in the UPTO application 60/891,534 “A Method and System for Invitational Recruitment to a Web Site” by the same inventors, referred to above) by e-mail that includes a link to a page which explains how the user has been pre-registered, using the e-mail address as a unique ID, and provides access to the WIP. The user contributes a password to this process, but otherwise needs only to input a few mouse clicks. “User” may also include a collective identity for a set of people (such as a pool of technical writers or legal specialists) who provide input on a who-is-available basis. “User” may also include a software element such as a checker of spelling or style, by preference with a significant natural-language-analysis component. (A checker of “Is this word in the list?” as in MSWord would accept “we are lead to believe”: A more sophisticated program would recognize that “lead” is not here a licit verb form.) Such tools are imperfect as yet, but steadily improving: it is thus better to provide a plug-in slot and a secondary market than to build a checking system rigidly into an office system. By allowing software to be a user in the present system, we achieve this even where some users continue attached to hegemonic software.

In moderated mode, the administrator assigns a Moderator (who by default may be the same user as the administrator). The Moderator sets policy, such as the paths by which proposals may be submitted, and the proposed time between drafts. To allow for periods of unavailability or for other problems, in our preferred embodiment the system may allow changes of Moderator, by action of the administrator, the current Moderator, or agreement of a pre-defined quorum of the work group members. The Moderator may begin the co-authoring process by issuing a first draft: if not, the formal first draft is an empty document.

In either mode, a user logs in to the system, connects to the particular WIP (if this user is involved in only one current WIP, this step is preferably automatic) and sees a Working List of versions for consideration. (The list may be empty, if this user is the first to contribute.) By default, the list shown is of the current leaves of the tree. The list of all versions, however, may be called up and displayed in various ways, possibly including but not limited to sorting by time, by author, by amount of new material, by amount of new material accepted/rejected in later versions, or as 2D or 3D display of the descent tree, according to the choices of the implementer and user feedback. Any one or more of the earlier versions in the expanded can be selected (for example, but not necessarily, by a double click) to add to the Working List. In our preferred embodiment this remains true in moderated mode: optionally the Moderator may be empowered to refuse such access to versions earlier than the most recent draft, and hope that suggestions refused in it will thus remain dead, but users can often resurrect zombie versions from their own files. Group harmony will not be enhanced by their finding a need to do so. In particular, a standard option can be to include by default the most recent version created by the user, even if it predates the current draft. Comparison with the present draft then enables a My Changes display, which identifies those elements new to that version and shows which of them have been adopted in the current draft or Working Copy, and which not, together with any comments entered in adopting or rejecting them by co-authors or the Moderator. This solves the problem (e) in the Background to the Invention, as modifications refused by the Moderator or by other co-authors in reaching the file used below as Working copy will then automatically appear as differences with that version. These differences may be assembled into a User Change Log, which shows the full history of the adoption or rejection of changes proposed by the current user, together with comments, and draws attention to repetitions or near-repetitions by the user of changes which are consistently rejected. The user enters editing mode, and the system displays the content of the Working List versions, with their differences. This may be done in several ways, depending on available resources such as display space.

Multi-window view If a user's display can show four or more standard pages with enough pixels per letter for clear reading, and the physical size of these letters permits easy reading for that user with suitable vision correction as necessary, it may be convenient to display (FIG. 7) a whole page or substantial page fraction of each version, grouped around the Working Copy 700 and with the other page displays 701, 702, 703, 704 and 705 in syncontent with it. (By analogy with synchrony, matched time, syncontent arranges that scrolling in one displayed page is tracked in the others by motion that preserves as close as possible a match to the displayed text. In the presence of gapped matches, this may involve jumps.) We illustrate this in an exemplary rather than a restrictive version, remarking that many alternate or additional features will be evident to one skilled in the art. Among these is the use of a unique color for each mismatch type to show its two mismatched strings and the arrow between them. One may also use for example different hues or hue groups (shades of green, shades of brown, shades of blue, . . . ) to distinguish mismatch types, and high saturation (‘pastels’) versus low to distinguish directions of change; relic difference given less dramatic colors than a new change. (The planning of such color codings should allow for the fact that in any group of seven collaborators there is a higher-than-even chance that at least one has some form of ‘color-blindness’, partial or complete. Distinguishability for such a user is important.) With a modern color display, much better use of effects such as translucency can be achieved than is shown in FIG. 7, and such use is within the spirit of the present invention.

The direction of the arrow 715 shows the gap 710 to be a deletion, with the string 711 in its descent, while the direction of the arrow 735 shows the identical gap 730 to be a relic, distinguished as above via use of the descent tree. (There is an important difference between a sentence that a collaborator has not yet seen, and one that she has actively deleted.) Left-clicking on either arrow 715 or 735 would result in assent to that deletion or absence, the removal of the string 711 from the Working Copy, and either disappearance or ‘ghosting’ of the arrows 715 and 735. (A ‘ghosted’ item keeps its shape and color, but is highly translucent.) Right-clicking on either rejects both, resulting in the retention of the string 711 in the Working Copy, and either disappearance or ‘ghosting’ of the arrows 715 and 735. These click conventions, like those below, may be reversed, changed to single and double clicks, replaced by key presses, or otherwise replaced by interactions known to those skilled in the art, within the spirit of the invention.

Conversely arrow 725 shows the string 727 to be an insertion, with the empty string 720 in the descent of version 702, while version 700 does not have the string 727 (or a near match to it) in its own. Left-clicking on this arrow 725 accepts the insertion, resulting in addition of the string 727 to the Working copy 700, and in disappearance or ‘ghosting’ of the arrow 715. Right-clicking on this arrow 725 rejects the insertion, resulting in no change to the Working copy 700, and in disappearance or ‘ghosting’ of the arrow 715. If the mismatch were a relic, the arrow would be reversed.

The arrow 745 shows a rewrite, where some co-author in the descent of 704 has replaced a match or match for the string 740 with the string 747. (If the replacement was in the other order, the arrow would be in the reverse direction.) Left-clicking on this arrow 745 accepts the difference, resulting in replacement of the string 740 in the Working copy 700 by the string 747, and in disappearance or ‘ghosting’ of the arrow 745. Right-clicking on the arrow 745 rejects it, with no change in the Working copy 700, and either disappearance or ‘ghosting’ of the arrow 745.

The arrow 755 shows a rewrite in version 705 of the string 750 “ssssssss” as 757 “ssssss”, which is not in the descent of the Working Copy 700. This proactive change is likely—given competent collaborators—to be a valid difference, and acceptable to the current user. The reverse arrow would indicate that a change from “ssssss” to “ssssssss” is in the descent of the Working Copy 700, and suggest that the version 705 simply lacks it because its descent does not include the version that made the correction: however, it is possible that a version in the descent of the version 705 actively rejected it, and the current user might agree with this, or might spontaneously reject the correction as invalid. We therefore do not automate the choice, which would save user time at the expense of user autonomy, but we do provide the arrow directions as cues to history. Left-clicking on the arrow 755 accepts the rewrite, resulting in addition of the string 727 to the Working Copy 700, and either disappearance or ‘ghosting’ of the arrow 715. Right-clicking the arrow 755 rejects the rewrite, with no change in the Working Copy 700, and either disappearance or ‘ghosting’ of the arrow 755.

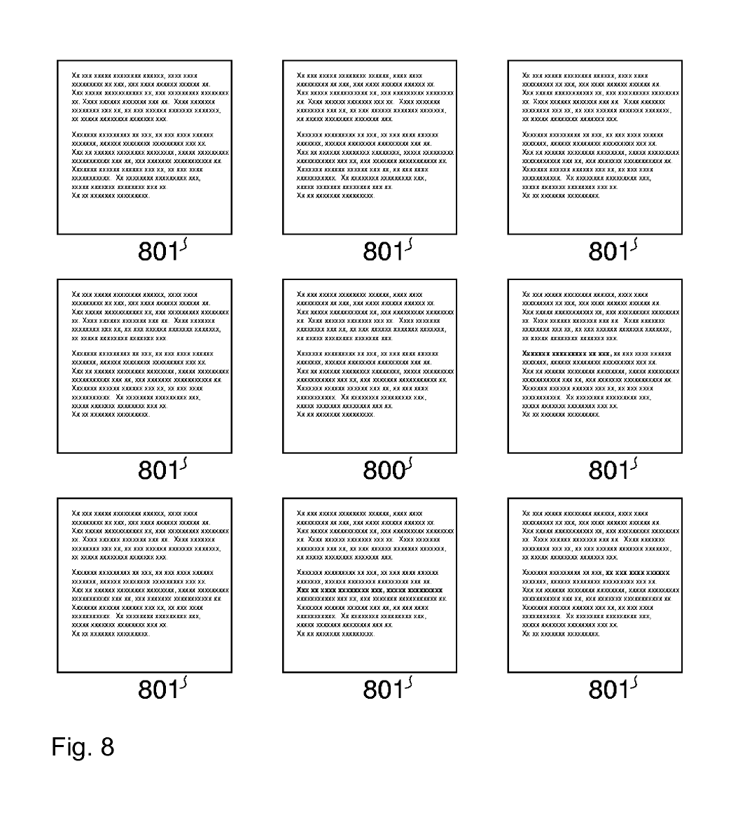

The multi-page display has its advantages, such as that one can compare the readability of versions in a direct read-though, but its limitations are evident. FIG. 7 uses very small ‘pages’ to illustrate it, so as to achieve readability within the currently common 1024 by 768 pixel display: with substantially more words per page, it would be unreadable on such a screen, as it would on a larger one seen by eyes that need large type With more versions to show at once, it also becomes harder to lay out with clarity. Ample space and resolution would allow (FIG. 8) eight versions 801 around the Working Copy 800, but a larger number would require a second ring, a second layer, a layered second ring partly hiding or hidden by the first, a scheme of protruding clickable tabs by which a window can be selected for visibility, or another arrangement within the spirit of the present invention. Many such will be evident to one skilled in the art, but as this is not our currently preferred embodiment we do not catalogue them at this time.

Similar graphical means can display permutations and transpositions, but it is more convenient to describe them in the context of the USPTO filing 60/869,733 “A Method and System for Facilitating the Examination of Documents” by the same inventors, incorporated above by reference. The compressed view there disclosed simplifies both viewing and rearrangement of text. In summary, in the said method the user is enabled to move smoothly between viewing an entire document in a word by word display, through views that display only elements of increasing landmark value, to an overview of the document in a single display window. A document is parsed into a hierarchy, of which each node at every level (from chapter to sentence, clause or long word) has a display state (invisible, tokenized or open) for the way it is shown as part of an expandable view of the document. The contents opted for display within a tokenized view may be prioritized according to a system of landmark values. The view is modified by user input using an explicit data structure of nodes and states within the device controlling the display, or by structuring in another system the underlying logic of the arrangement of code that is acted upon by a web browser. The section hierarchy may be explicitly coded in the document format, or reconstructed from typographical evidence.

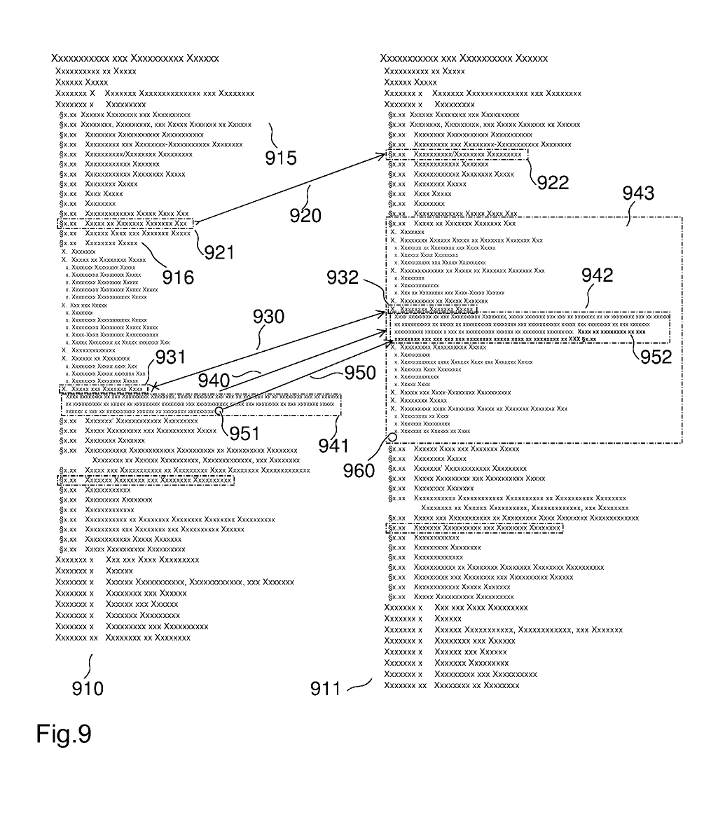

The results are illustrated in the two views in FIG. 9, with differently compressed views of a single large document. (Each § section would require multiple pages of print.) In the left panel 910, most chapters are tokenized as their headings: optionally, an icon such as “ . . . ” can be added to each to indicated that it can be expanded, but this is omitted here. The second chapter 915 is displayed in an expanded state, with most of its § sections tokenized as their headings. Section 216 is displayed in an expanded state, with many of its subsections tokenized as their headings, others including their headings. Subsection 941 is displayed as open text. All of these levels of display may be modified by user interaction, such as moving the cursor to the right on an element to open it, to the left to tokenize it or make it invisible. The right panel 911 shows a similar view of a revised form of the document, with different regions expanded, again subject to user input. Many user input schemata for such control are detailed in USPTO filing 60869733. Their details are not critical to the present invention, which does however address the system-initiated changes in display level.

The >-> arrow 920 indicates in this exemplary drawing that something within the element 921 has moved to the element 922; expanding element 921 by the chosen user-input scheme would result in a matching expansion of the element 922. If the expansion still shows only a subsection containing a moved element, a new >-> arrow will show the subsection of the element 922 to which it has moved: this requires that the said subsection be shown, in tokenized form, and hence that the elements containing it be open. This occurs automatically, by the rules embodied in the system, rather than by the user having to modify both views. Alternatively, the user could expand the display of element 922. The display of element 921 would expand accordingly, to show the context from whence the addition came. (The gap 960, however, might be the user's object of interest, so an expandable link to the element 921 from which it was taken—and moved according to the arrow 920 to somewhere in the element 922—may optionally be shown.) Expand to the level where individual sentences are open, and the specific moved text comes into view. In the case of Subsection 941, just such a matched expansion has taken place. The left panel 910 thus shows the text 941 which by the arrow 940 has moved to become the text 942, in a different § section expanded 943 sufficiently to show the text 942 in context and conform to the rule that the parent of an open or tokenized node is always open. The hierarchical context makes clear that the parent 931 of the text 941 has not merely moved to, but been rewritten as, the text 932. This is indicated to the user by a x-> arrow in this exemplary drawing: alternate arrow stylings will be evident to those skilled in the art, within the spirit of the present invention. Within the text 941 there is a gap 951 which is matched to the inserted text 952, as indicated to the user by the arrow 850, analogously to the insertion arrow 735 from the gap 730 to the highlighted string 711. As in that case, our preferred embodiment uses highlighting means characteristic of a computer display (such as color or blinking) rather than hard copy emphasis methods such as bold face, which may be present in the text and should not be confused with software highlights.

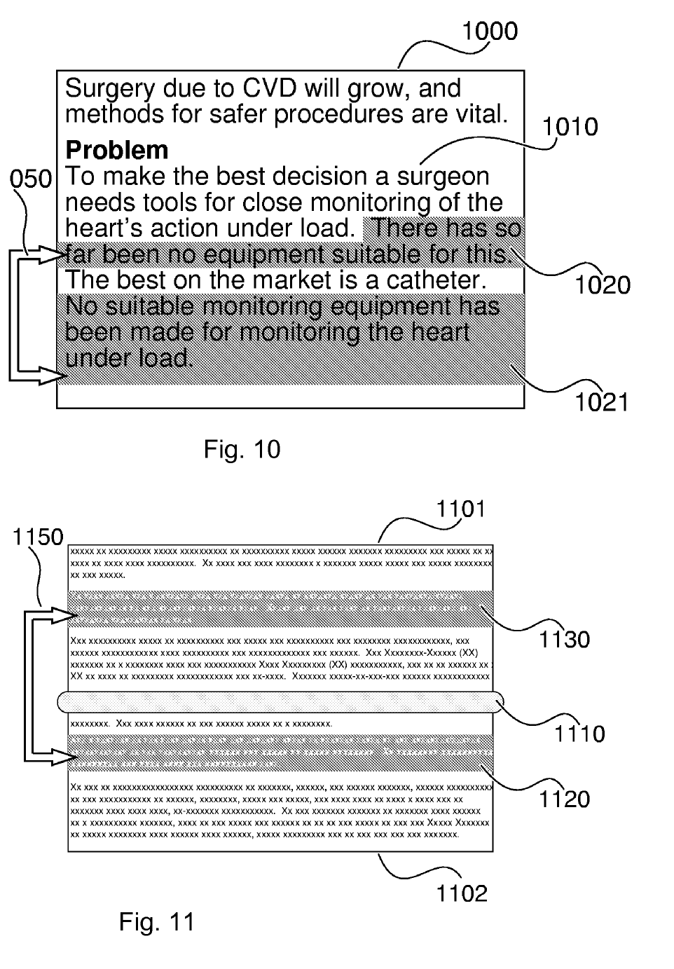

Single-page view: single file We begin discussion of the single view with the case of presenting a repetition, discussed above under single-file comparison. We first describe the uncompressed-display version. FIG. 10 shows an instance (already introduced) where the near repeated strings 1020 and 1021 can be shown simultaneously in one window 1000, showing without gaps the text 1010 in which it is embedded. An exemplary graphical display can then simply display the text 1010, highlight the strings 1020 and 1021 by means such as but not limited to change of text color, background, font, size, boldness, italicisation, underlining, blinking or other features well known to one skilled in the art, and add a graphic element such as the double arrow 1050 to link them. Many variants of this will be evident to one skilled in the art, within the spirit of the present invention.

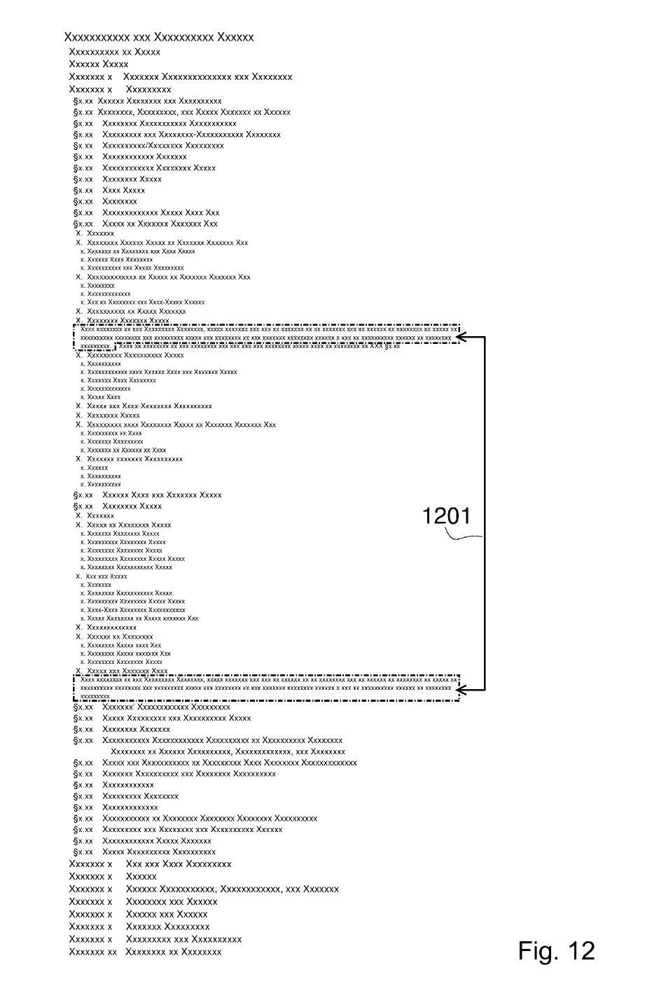

The normal user choice, faced with such repetition, is to fix in which context the repeated item should remain. It is thus appropriate to display some text around each. If two or more repeated strings are far enough separated that this cannot be done in the manner of FIG. 10, then one means to achieve it is by split windows 1101 and 1102, as shown in FIG. 11. A divider 1110 makes it clear to the user that these are separate windows, without run-on of the text between them. (Alternatives to the form shown would include a lateral shift of one window relative to the other, a visual suggestion of one paper lapped upon another, and many others that will be clear to one skilled in the art.) Highlighting the repeats 1120 and 1130, and representing them 1150 as in FIG. 10, displays the repetition in context. However, the sense of where the contexts are located in the document is limited.

Our preferred embodiment, however, and one that becomes far more necessary if the repeated units are longer, is to use the variable compression introduced in FIG. 9. Suppose for illustration an editor who intended to make the transposition shown in FIG. 9, but performed a ‘copy and paste’ rather than the intended ‘cut and paste’. Our preferred display of the existence of the resulting duplication uses a single compressed window as in FIG. 12, where the double arrow 1201 is analogous to 1050 and 1150.

Another single-user aspect of the present invention is that of structured Undo. The incremental change storage in our preferred embodiment lets OmniPad back-track through changes in a document, section, paragraph or other defined part, re-creating something that the user interface can treat as a comparison document, in precisely the framework used for any other, importing differences on any scale. (Thus, for example, “undo the changes in this paragraph” becomes effectively “import the earlier version of this paragraph” in a unified interface; or parts of it, or individual differences, can be imported. The fact that some of these changes were made before a correction in another paragraph, and some after, does not complicate the user's experience.) The user need merely define the active part, by selection mechanisms that will be familiar to one skilled in the art, set the previous version used for comparison (by default the version that was loaded to create the current Working Copy, but allowing selection of an earlier version from the descent tree or by a widget such as a slider controlling the reference time, or by other means evident to one skilled in the art). The user then proceeds to use the Undo feature, which may use an option permitting the user to undo all the changes in the active part with a single command, or a display showing the changes in the selected region of text, which the reader may read through and accept or undo individual changes, or step back through the changes in reverse temporal order. In the latter case, optionally the user may choose to let a change remain, but without (as in standard Undo) losing access to changes that occurred earlier. The selected region is redefined to exclude the text containing the change permitted to remain, and the sequential Undo proceeds as before.

“Undo” is traditionally a single-file function, and can be handled in a single-window view, making it appropriate to list here. However, its logic and interface are better appreciated as comparison and interaction with an earlier self of selves of the current file, and can also be handled by the multiple-window approach above, and with the variable compression illustrated in FIGS. 9, 12, 19 and 20. (In the latter case, the compression varies as the user steps through an Undo sequence, with least compression applied to the text affected by the current Undo candidate action.) We do not give it further separate treatment.

Single-window view: multiple files We now address the presentation in a single window of differences between a file and one or more of its neighbours. What follows is an exemplary single-window embodiment of the editing and merging use of dynamically matched texts, not to be construed in a limiting sense; many other interaction schemes can be developed within the spirit of the present invention.

An embodiment within the spirit of the present edition could follow a classical “variorum edition” layout, with all alternative forms and spellings side by side, or in columns, with attribution. This is helpful to scholars, handles well the fact that Hamlet's script may have said “Oh that this too, too sullied flesh should melt” (though not that he might have pronounced it to suggest “solid” also), and is well supported by fixed print. It is cluttered, however, and poorly suited to describing rearrangements of the text. A multi-threaded narrative like Orlando Furioso could transpose dozens of pages without disturbing the logic, and the creator could well make such a change for impact. Most 19^{th} Century novels were more fixed in their sequence, many 21^{st} Century business documents are less so. (Do you put the Marketing section before Technology? This can change with the intended readers.)

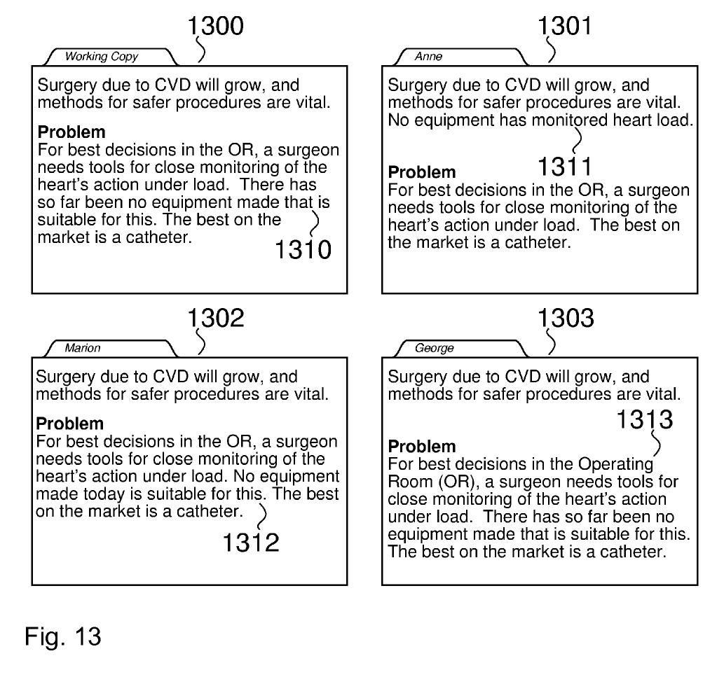

We describe first the presentation of small scale changes, that (like the repetition in FIG. 10) can appear within a page of text. As exemplary Working Copy we take the material from FIG. 10, but with the repetition resolved. The document it is part of is taken for illustration to be the base for three alternate versions. FIG. 13 shows it for background in a multi-window style like that of FIG. 7, as windows 1300, 1301, 1302 and 1303 representing respectively the Working Copy and variant versions by Marion, Anne and George. Anne moved a sentence to 1311 and revised it, Marion tightened its language but left it in place, and George told the reader what an OR is. Godot has not yet contributed a version, so no page is shown for him here. These differences could be presented as in FIG. 7, but that embodiment is not our topic here.

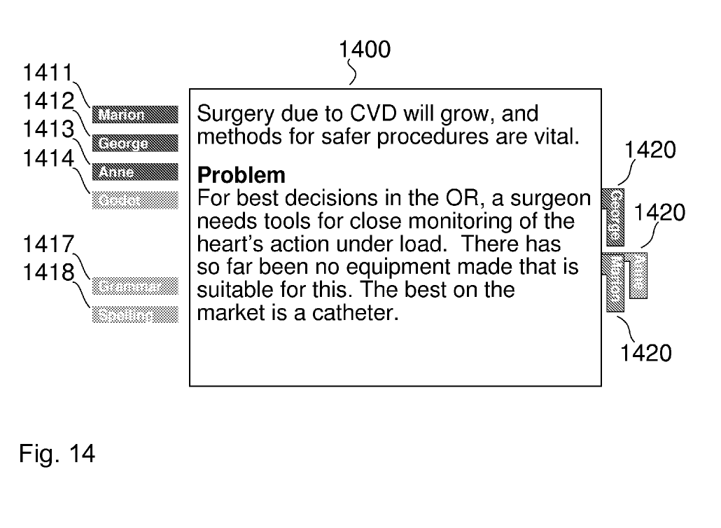

In our currently-preferred embodiment of a single-window interface, FIG. 14 shows 1400 a page from the Working Copy, open to the current user (who may be the Moderator, or one of the named authors). The source buttons 1411, 1412, and 1413 show that Marion, George and Anne have contributed versions This is a form of the Working List referred to above, using author names as identifiers. Other such displays containing more or different information will be evident to one skilled in the art, but this format does not overload the user. In the unusual event that one author has contributed two ‘leaf’ versions, neither with descent from the other, we create buttons labelled (for example) Marion₁ and Marion₂. The button 1414 for Godot is greyed out, as are buttons 1417 and 1418 for the spelling and grammar checkers, implying that these have not yet been run on the document. If the user were to run them, or if they were to run in background by default, these buttons would appear as live. The tabs 1420 show places where the different co-authors have proposed changes, with their thickness showing how many lines of text are involved. Note that only one tab occurs, in this case, for Anne. If we did not recognise the second paragraph in her text as transposed from the original fourth paragraph, we would show another tab there, for an insertion.

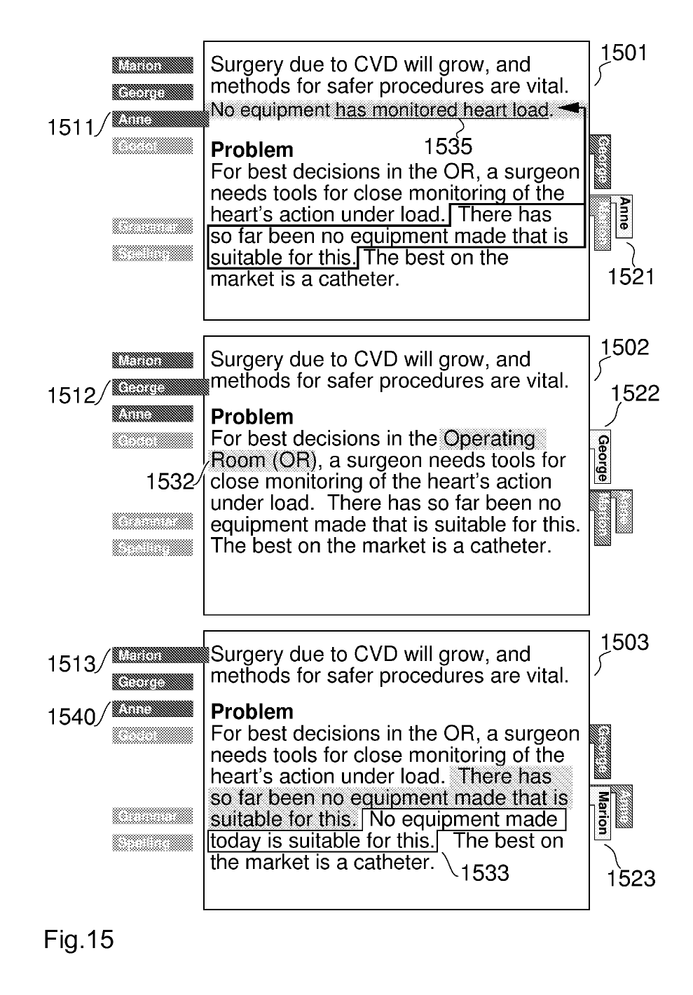

FIG. 15 shows the separate results of clicking the source buttons 1411, 1412 and 1413 in FIG. 14. The corresponding button 1511, 1512 or 1513 extends to encroach on the window, 1501, 1502 or 1503 respectively. So many alternatives within the spirit of the present invention will be apparent to a person skilled in the art as to pose the problem of getting one chosen and coded, and the next task started.

In each case the tab 1521, 1522 or 1523 is greyed to show that its ‘contents’ (differences they draw attention to) are already on display. When a source button is clicked, each tab related to the corresponding file has its contents displayed, including those only visible when the window is scrolled. Window 1501 shows the transposition 1531 proposed by Anne, together with her deletion 1535. (In editors following the current state of the art, the change 1535 would be lost for display purposes under the under the movement, displayed as deletion and insertion. Window 1532 shows in-line, and highlights, the small insertion 1532 proposed by George. The sub-window 1533 in window 1503 shows as a slip (boxed passage of text) the revision proposed by Marion. Double-clicking any one of these changes accepts it, and the text adjusts to show the result, without highlighting it unless another reason exists to do so. Clicking the tab itself rejects it, and the highlighted change display disappears. In either case, the tabs remain for later reference.

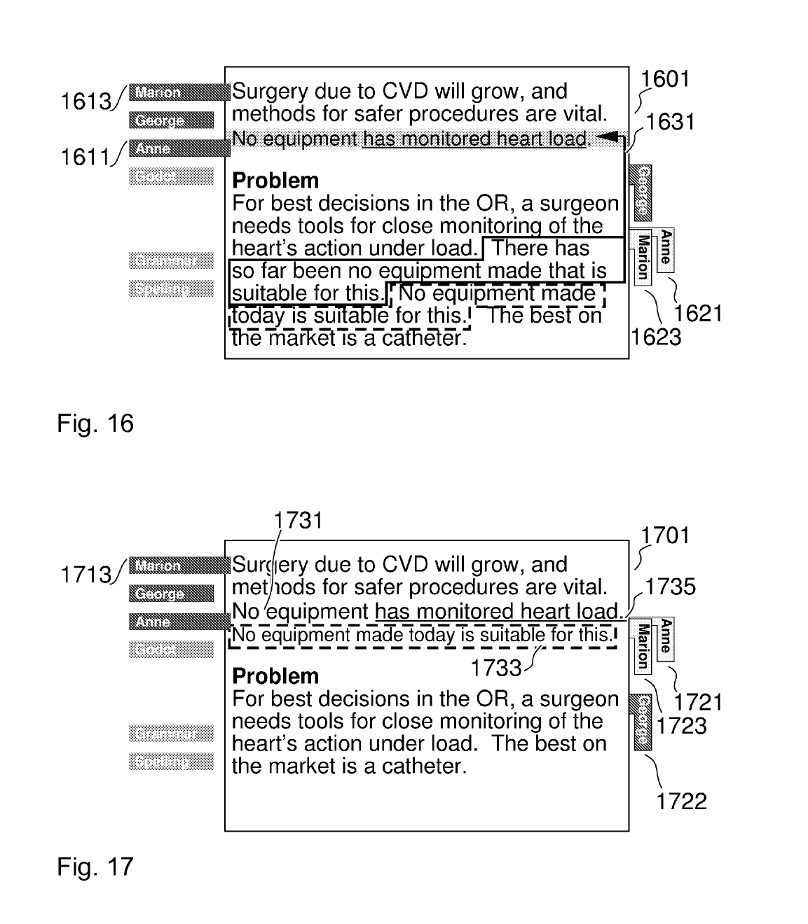

FIG. 16 shows the result, not of accepting or rejecting a specific change, but of clicking button 1540 in FIG. 15. The changes 1631 and 1633 of both Marion and Anne are now on view, and both buttons 1611 and 1613 encroach on window 1601. The tabs 1621 and 1623 are both grey. Double-clicking the change 1631 accepts it, giving FIG. 17.

In FIG. 17, the transposed text 1731 has moved to the new location. So have Marion's proposed change 1733 in it, and the tabs 1721 and 1723, since this location in the newly current version of the Working Copy is the place where both differences are most relevant. Even if Marion's text were not in the active state, shown by the fact of her side source button 1713 encroaching on the window 1701, the tab 1723 would have followed the moved text 1731. The tab 1722 for George's change remains at its original location relative to the text, though its window position has moved due to the space opened to allow non-obscuring display of the proposed change 1733. Anne's change 1735 within these two sentences, as well as her moving them, could be collectively accepted by double-clicking on the slip 1533 while it is still boxed (before double-clicking on the transfer arrow 1531 or 1631). After the move, it can be double-clicked individually. Alternatively, if any contiguous text region is selected via the mouse in the usual way, clicking an ‘All Change’ button elsewhere (not shown) in the display accepts all displayed differences except where they conflict among themselves.

Had Marion's change been a brief one like George's, normally displayed within a line, it would follow 1731 and be marked in-line there. If the match of Anne's and Marion's revision of the two sentences moved by Anne meets the normal criteria for in-line display, Marion's version is displayed in line, rather than in a slip 1733.

Where multiple versions of a short stretch of text exist, our preferred embodiment allows the user to switch to a display like FIG. 7, except that rather than show whole pages in the surrounding windows, OmniPad uses smaller windows showing all competing slips for that stretch of text. Where two or more are identical they appear as a single slip, optionally with the names of all co-authors whose versions use that common string. Our preferred embodiment continues to give context in the Working Copy window, but considerations of space or personal taste may permit this window also to show without context even the slip from the Working Copy.

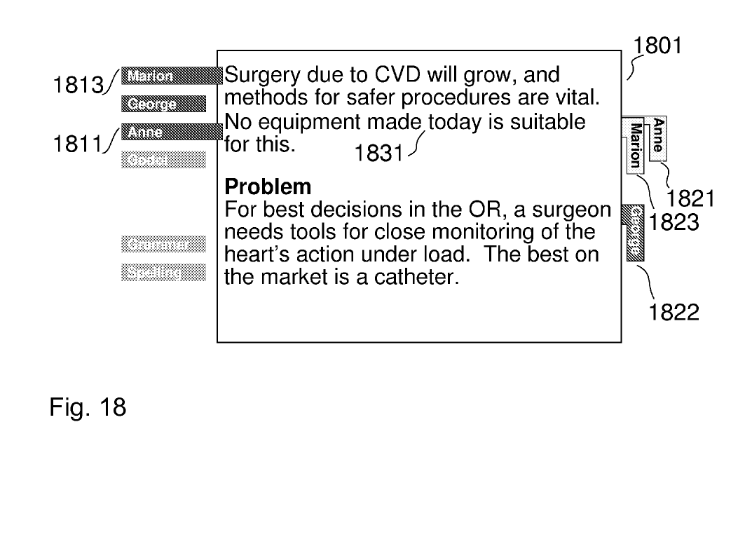

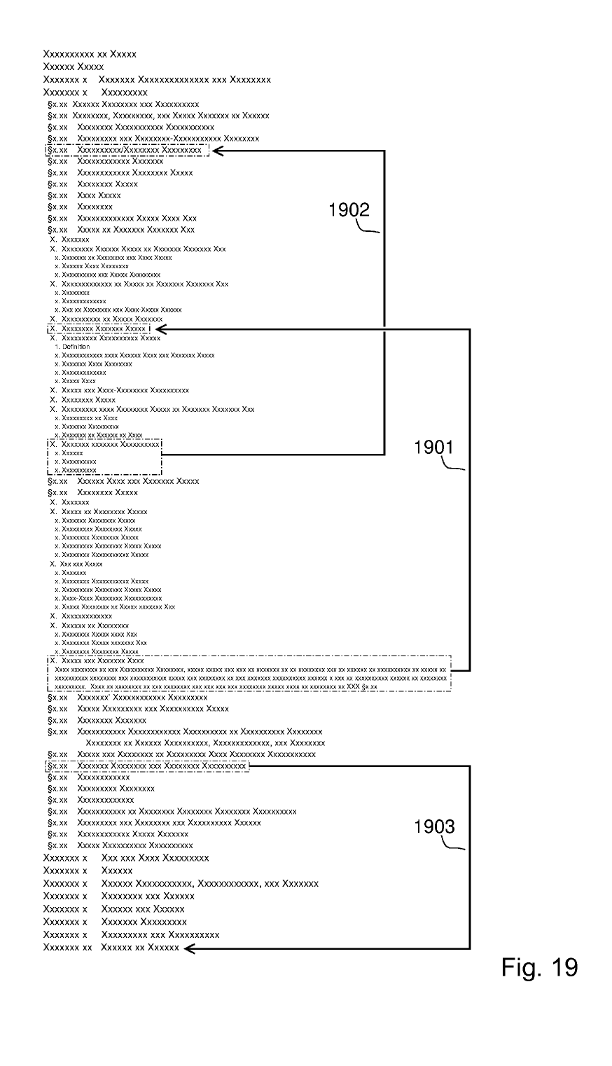

Double-clicking the proposed change 1733 gives the situation of FIG. 18. The new two lines of text 1831 appear un-highlighted, though Marion's and Anne's tabs 1821 and 1823 are still present (with adjusted widths) at its location. A next user step might be to accept or reject the change from George, marked by the tab 1822 (still un-greyed), or the user may scroll or otherwise move on through the text.

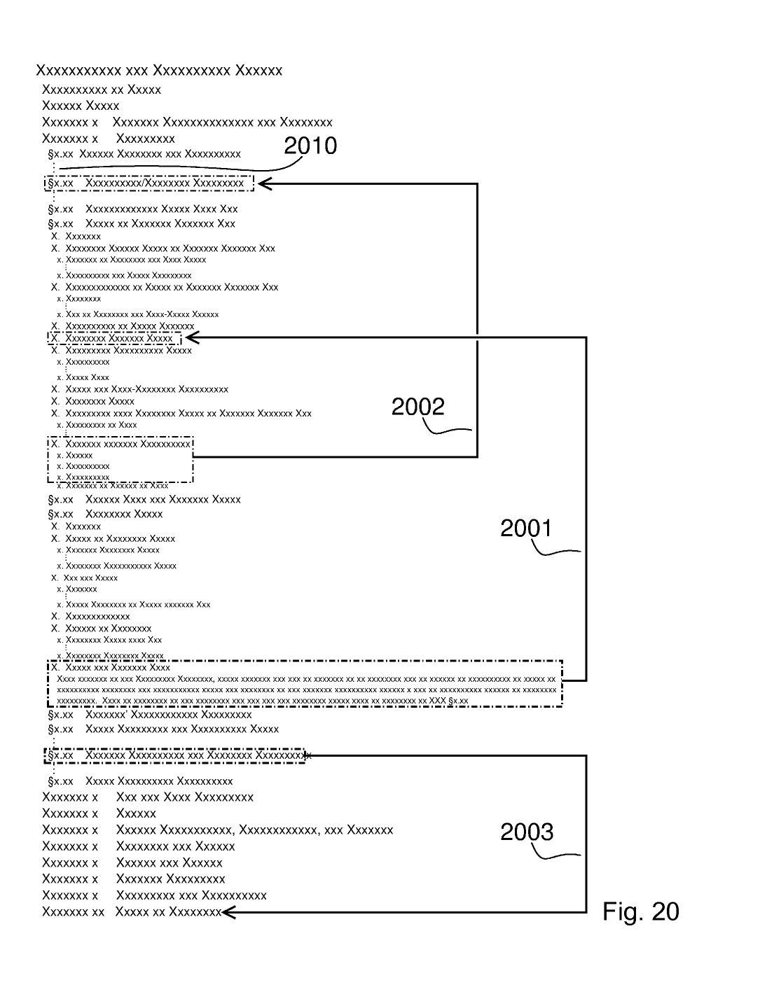

In general the highlighting of changes in tabs is color-coded, using saturated colors for relic mismatches, dramatic unsaturated ones for those representing novelty. (Other ways of representing this distinction, within the spirit of this invention, will be evident to any person skilled in the art.) Our preferred embodiment contains a default set of colors, constructed in consultation with persons skilled in the lore of human color perception and its variations, but is customisable either color by color or through selection of an alternate pre-constructed set.

Where describing a single difference does not fit within a single, contiguous page display at comfortable resolution, our preferred embodiment again uses variable compression. FIG. 19 shows three transpositions 1901, 1902 and 1903 that start in the same § section, which has been expanded by user interaction. Our preferred embodiment makes a trade-off between full description of a move and compression to display window size, so in this case the target locations are not fully expanded until the user selects them individually. A more aggressive compression (FIG. 20) does not insist that all the immediate children of an open node be visible in at least tokenized form, using ellipse markers 2010 to omit some more distant from the places where the view is more expanded. This shows the same three transposition 2001, 2002 and 2003 in what could be a smaller window, or (as here) larger print. If this saving permits, the arrival locations can expand to show the transpositions in more detail. In our preferred embodiment, the trade-off between target location detail, window size and print display is adjustable by the user, with default the trade-off chosen by most users in pre-release tests or in ongoing monitoring of the editor as a web service.

Local changes such as rewrites, insertions and deletions clearly fit equally well into this display scheme. Where text is displayed in the fully open state, the mechanisms described for the uncompressed version apply without change. Where it is not, the invention simply applies the tabs and other change markers to the compressed version. To see that a paragraph or section has moved, and from where to where it has moved, the user chooses a high-level overview display. To see how it has changed while moving, the user moves in for a closer view. This solves problem (c) listed in the Background to the Invention.

### Group Workflow

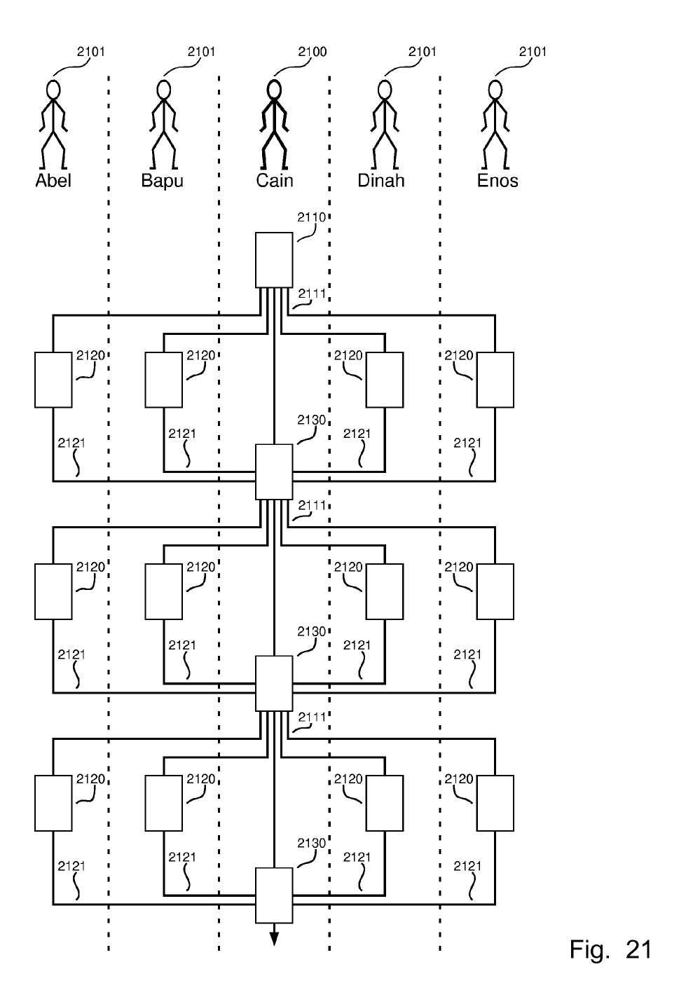

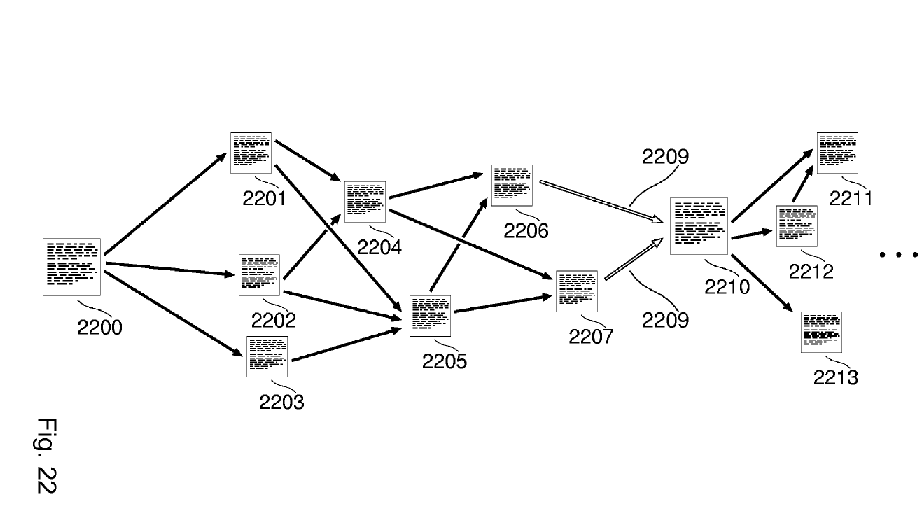

FIG. 21 illustrates the most centralized yet most parallel version of moderated editing. One or more co-authors 2101 (here shown as four) join with a Moderator 2100 to write a paper. The Moderator 2100 writes or otherwise obtains a first text, and 2111 issues it as a formal draft 2110, perhaps with a deadline. By e-mail, by making it available for download or for editing, or by some other means, OmniPad distributes it 2111 to the co-authors 2101, who separately edit 2120 and 2121 return it. OmniPad also keeps available a copy of 2110 to be used as the Working Copy 2130 of the Moderator's next interaction with the text, rewriting with the input of the copies returned 2121, but free like the others to add new material. The Moderator finishes this step, and again 2111 issues a draft. The cycle repeats until there is agreement that the paper is finished, or close enough to it to get past the referees, the review board, the lawyers, the USPTO or the public as the case may be.

The present invention supports this workflow, but it is not the most usual among collaborators. Commonly each author makes a new version and sends it (often by email) to everybody. To avoid re-inventing the wheel, another author who has not yet started on this round's editing—and is stirred into action by receiving another's copy—takes the new version into account, even using this and not the official draft as an editing basis. If there are two already, take account of them, and so on. It easily happens that the flow of FIG. 1 recurs, with the Moderator-issued draft as the starting point 100, before a new draft is issued.

Rather than try to enforce the flow in FIG. 21, our preferred embodiment of the present invention adds the rule that the Moderator can officially save a version as a collective draft. (This is distinct from saving part-way through editing a document, when going off to lunch or a meeting.) OmniPad automatically considers this to have descent from all earlier versions, with internal matching evidence, making it the only leaf on the tree. In FIG. 22, we have an original draft 2200, a ‘free for all’ where various authors create new versions from it and from each others'. (The Moderator may choose to participate in this, producing a draft without characterising it as a draft ex cathedra moderatori, from the Moderator's chair and hence infallible.) When the Moderator issues a new draft 2210, the descent arrows 2209 exist by fiat. The draft 2210 becomes the sole new leaf (the first leaf with this status since version 2202 was created). All Working Lists now include it automatically, and it is sent as an official draft to those co-authors participating by email, or otherwise not logging in to OmniPad directly. Versions like 2211, 2212 and 2213 automatically are ascribed descent from it. (Optionally, OmniPad may check that internal evidence suggests they have taken notice of the new draft. If one has not, the Moderator may choose to take corrective action outside the system.)

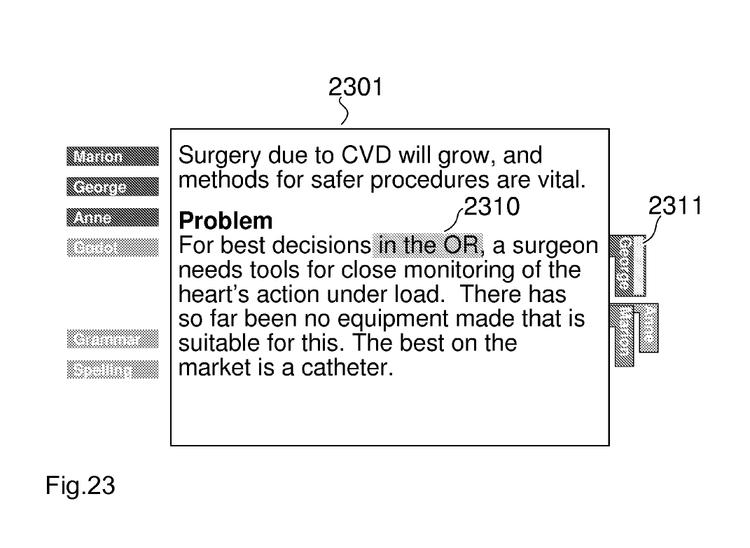

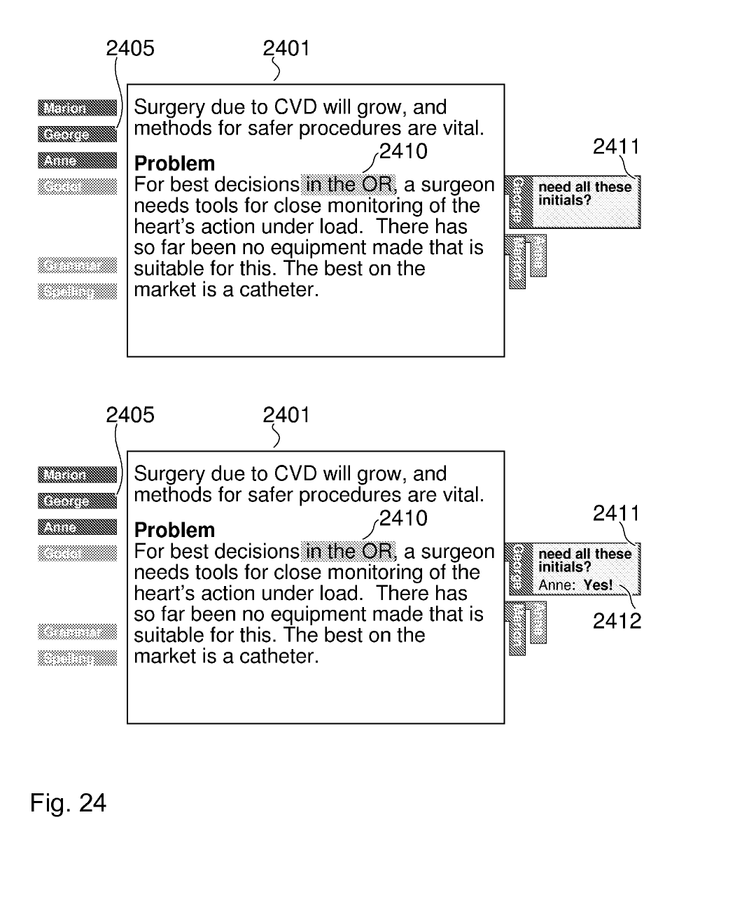

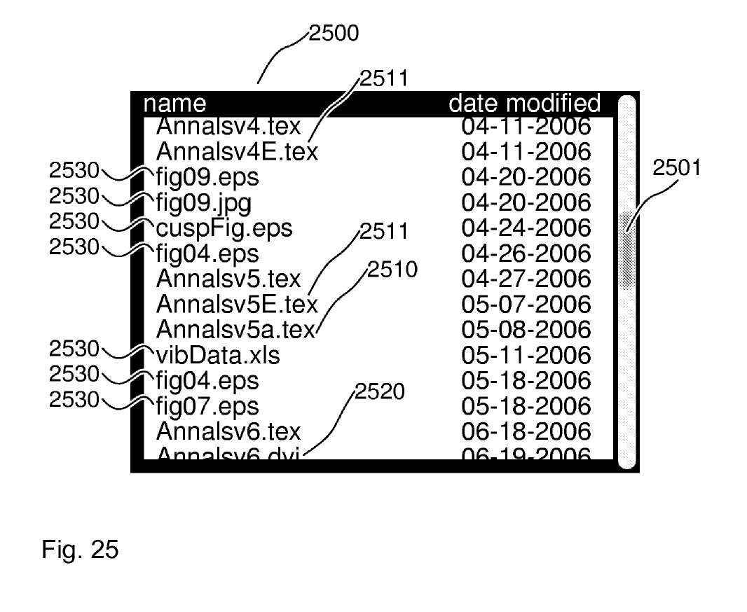

FIG. 23 shows in the window 2301 the way in which our preferred embodiment communicates comments. In this instance George has earlier selected an area 2310 of text and opted (by pressing a button, a particular keyboard key or combination of them, or by other means familiar to those skilled in the art) to enter the text of a comment. The highlighting 2310 shows the object of the comment, while a tag with the added strip of ‘comment’ color shows that the comment is by George. The current user may ignore this tag, select it with a single click and then delete it sight unseen (for example, by pressing Ctrl-D or the Delete key), or double click to display the contents of the comment. FIG. 24 shows 2411 one option for the graphical layout of such a display: many others will be evident to one skilled in the art, within the spirit of the present invention. (The button 2405 does not abut on the window 2401 because the current user has not selected ‘all George's input’ by clicking it: only the current comment, by clicking on one George-marked tag.) The comment may still be deleted, or the current user (for illustration, we suppose this to be Anne) may add a reply 2412 which will be seen by other authors when editing after this version has been saved. In one implementation of this, Anne simply places her cursor within the comment window 2411 and enters text with the keyboard. Clearly, if this dialogue grows, the user interface may usefully offer a larger window for its display, by many of the means evident to one skilled in the art.

Another author such as Marion, working on the document after this version has been saved into OmniPad by George, will see the comment and reply 2412. If there has in the meanwhile been a response also from Godot, the dialogue will be folded together in temporal order. (Optionally, if a complex discussion develops, it may be preferred to move it into a more separated display with descent tracking.) Marion is free to add to or delete the dialogue. If a user deletes a comment, with or without additions by other users, it disappears from her view of all later versions unless and until a reply is added which she has not seen. In the latter case, the dialogue reappears as a whole, with the earliest entry after her deletion displayed in focus position, with earlier and later entries above and below it or available by scrolling.

### Web Interface and Infrastructure

Our preferred embodiment of the present invention is in the form of ‘software as a service’ (SaaS), delivered by means of the web, though many local embodiments will be evident to one skilled in the art, within the spirit of the invention.

In this embodiment, copies of the versions discussed above are kept on a server maintained by the service provider; an author can
i. create a new WIP, to which she automatically has access
ii. see the variants currently in any WIP to which she has access privileges
iii. upload a new variant to any WIP to which she has access privileges
iv. download a variant, with or without OmniPad annotations
v. edit a variant using OmniPad.
vi. invite new authors to join any WIP to which she has access privileges.
   Optionally, (vi) may be permitted only for the WIP's Moderator, if such exists, or the WIP's creator under (i). Each of the above items requires further discussion.

When a user first connects to an OmniPad web site, she establishes a means of continuing access to the site and to a space she controls, to files within it, and in some cases to files within the space controlled by other users. In our preferred embodiment, each WIP exists in the space of its creator under (i). This may be by the process of registering an OmniPad identity and agreeing a password with the site, as is now standard in many web sites (with variants such as whether a user-created password is typed in, or a server-created one is emailed to the user's address). If the user initiates the contact, this will be the normal process, perhaps involving the payment of a subscription fee, perhaps gaining access to an introductory level of free service. If the user is responding to an invitation from an existing member, this process may optionally be abbreviated by use of the email ID to which the invitation was sent as a default OmniPad identity, and use of emailed single-use links as an alternative (once or repeatedly) to a password. These options are discussed in more detail in the USPTO application 60/891,534 “A Method and System for Invitational Recruitment to a Web Site” by the same inventors, referred to above. It suffices here to assume that each member of the site has access to it, and in particular that each member of the work group associated with a particular WIP has access to that WIP, whether it be in that member's space or another's.

FIG. 25 shows the typical list that a co-author of a paper faces, where only email is used for version management. In this instance the principal author attempted to maintain sequence indicators in the names that files were saved under: When he sent three colleagues a version such as Annals5.tex, he was likely to get revised versions with no change in name or number. Saving them from email he added an “a” or “E” (co-author initials) to avoid their overwriting each other or the recently sent out draft. Doing this manually, at irregular intervals, it is hard to keep it consistent. They might be returned as “.tex” L_{A}T_{E}X files (which require compiling for readability of the equations, and which must be accompanied by image files for the illustrations) or as inclusive but hard to modify “.pdf” Portable Document Format files, or both. The folder also contains files 2520 generated by the L_{A}T_{E}X compiler, and a substantial number of files 2530 kept near the textual material by ongoing struggle with an operating system which by default puts such files into a distant My Pictures hierarchy. Returning to a folder display like FIG. 25 after a hiatus such as a vacation or other work, it can be laborious even to see which files should be looked at, let alone absorb and merge their changes.

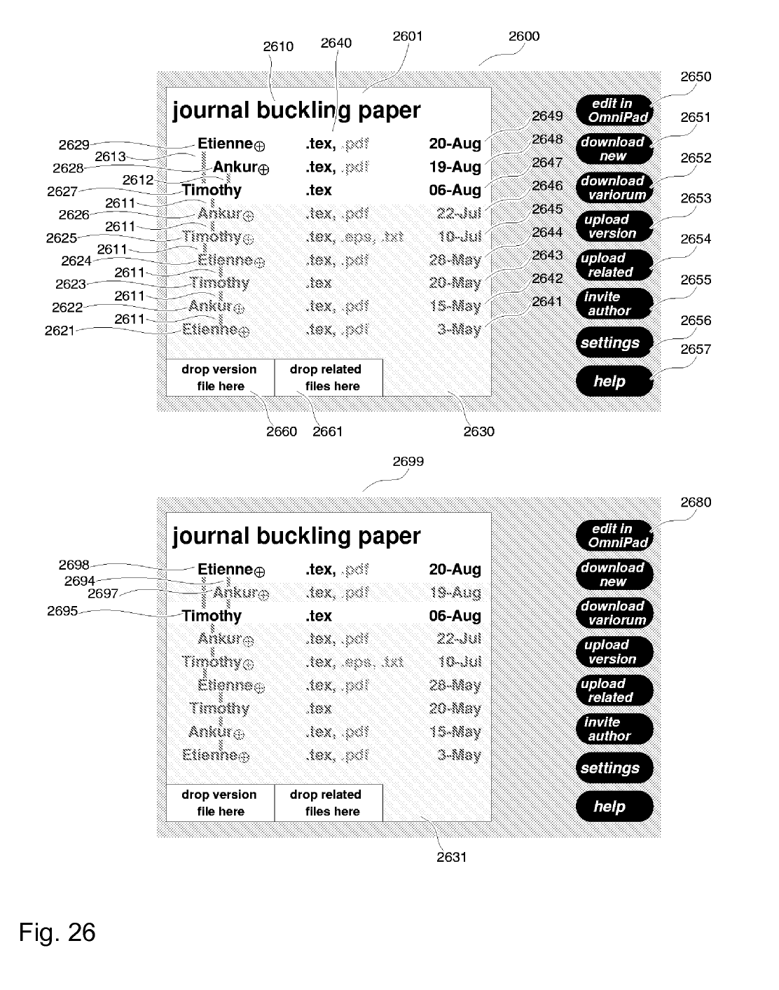

It is a primary purpose of the present invention to make this easily apparent, even to a user who does not open a file in an OmniPad editing environment (as disclosed above in a plurality of embodiments). In contrast to FIG. 25, FIG. 26 shows a descent-tree oriented view of the versions in the WIP, as presented to the author Timothy according to his preference settings. It would be within the spirit of the present invention to present a view such as FIG. 1 or FIG. 22, or a view with the relative displayed position of later files to the left, above or below earlier ones replacing the left to right ordering of those Figures, but we here illustrate a more compact display. (Screen area is a scarce resource, second only to user patience.) An embodiment may offer either of these approaches as a default, with an Options setting for the user to change the choice. In the style of FIG. 26 a ‘last at the bottom’ orientation would also be acceptable; our preferred embodiment allows user choice between these options. Where more files are present than can appear in the available space at the current font size, the most recent files should be displayed in the opening view, with those excluded made available by scrolling.

A window 2600 appears within a browser, or (as discussed later) as an apparent window of the operating system (Windows, MacOS, etc.). Within this is a subwindow 2601 for the contents of the WIP, which in this illustration contains successive versions of a single document, rather than of a connected set of documents. (Extensions necessitated by the latter case will be evident to one skilled in the art.) The overall WIP title 2610 need not be repeated in the display of the individual files, so—irrespective of the filenames under which they are stored in the server—they are identified by uploading author and by date. (A consistent system of version numbers could be automatically generated, but for our preferred embodiment we consider this unnecessary.) The marker ⊕ indicates the presence of supplementary material such as graphic files in PostScript (“.eps”) or image formats, compiled versions such as Portable Graphics Format (“.pdf”), text explanations—too big for comments—of why the uploading author made certain changes, or text suggestions of what other authors should do next, test code that implements an algorithm discussed in the document, or any other associated matter the author chose to upload in the same session. (On gaining access within a set number of hours, such as 12, after an upload, the user may be asked by a dialogue box “Continue session?” so that a web interruption need not mar this relationship.) Clicking the ⊕ icon opens or switches to a window showing the associated material. The column 2640 shows the file types present at a particular point in a similar history to the one that produced FIG. 25, with more prominence for the type or types of the main version than for the supplementary material. One may add other standard information about files, such as the storage space they require. The display lists the uploads in date order, rising or ascending, with direct descent marked 2611, 2612 and 2613. By default, in our preferred embodiment, dates are listed with letter abbreviations for months: the collaboration this example is based on had authors in India, England and the US, with conflicting numerical date formats. Our preferred embodiment also makes the format context sensitive, for example omitting year numbers that coincide with the present date, and hour and minute numbers if day data suffice to distinguish the entries. An individual user may personalise the date display, including the use of local time or a shared standard. From this display the history of a document is easily read by anybody involved, partly as direct information and partly as reminder. In this instance, Etienne created a draft 2621 (starting from a conference version, not shown), uploading it 2641 on the 2^{nd} of May, 2006. On 15 May 2642, Ankur added requested matter 2622, with new images included in the compiled .pdf file. On 20 May 2643 Timothy sent a revision 2623 of Ankur's L_{A}T_{E}X file, but added no new figures. On 28 May 2644, Etienne sent a new revision 2624 and asked for new material expounding the mathematics. After a hiatus Timothy responded 10 July 2645 with a revised L_{A}T_{E}X file 2625, new PostScript figures, and a text file explaining what was included and omitted, and why. He asked for new numerical output figures to illustrate these points, which on 22^{nd} July were included in the .pdf version of Ankur's upload 2626. On 6 August 2647 Timothy uploaded a revision 2627, to which on 19 August 2648 Ankur responded with an upload 2628; Etienne from another time zone uploaded 2629 on 20^{th} August, without incorporating any matter from Ankur's upload 2628. OmniPad has detected this by string comparison, and does not include the direct descent marker 2614 shown in the alternative version 2699 of the window 2600. It is thus immediately clear to Timothy, looking at the window 2600, that he must work with the two versions 2628 and 2629, and consider their changes from his own latest version 2627 as Working Copy. Versions that (by the descent detection algorithm) Timothy has already worked from are in the gray area 2630, further clarifying this difference.

Double clicking a version opens an additional window, optionally in a new browser tab, in which a compressed version of the kind illustrated in FIGS. 9, 12, 19 and 20 is used to display where this version differs from those from which it has direct descent. If the changes are localised, the parts that contain them are shown in a less compressed manner than the parts that do not.

Timothy may click on the button 2650, in which case these three versions are the default set brought into the OmniPad editor, including all the slips, tabs and other apparatus discussed above. If he has selected any versions in the gray area 2630 they will be included.

In the case of the alternative version 2699 of the window 2600, the default is to deal with only the most recent upload 2698, and consider its changes from his own latest version 2695 as Working Copy, as shown by the inclusion of everything else in the gray ‘dealt with’ area 2631. This relies on Etienne's judgement with respect to inclusion, omission or modification of Ankur's changes in upload 2697. However, if Timothy wishes to include upload 2697 directly, he can click to select before clicking the edit button 2680 for this case. Alternatively, he may choose to click his own previous upload 2695 to deselect it, and work only from Etienne's version 2699 with a fresh eye. The editing proceeds as discussed in the pages above, and the final Save of a session is considered an upload for purposes of generating the descent tree as used in the display in FIG. 26. (On gaining access within a set number of hours, such as 12, after a Save, the user may be asked by a dialogue box “Continue session?” so that a web interruption need not increase the visible number of versions.)

Alternatively, Timothy may choose to work with the files on a local computer. Since image files are often large, if the successive versions all directly contain them the time for upload and download may become unnecessarily large. If they are stored separately as supplementary files, with access via the ⊕ buttons shown in FIG. 26 (many alternate access schemes will be evident to those skilled in the art, within the sprit of the present invention), only new or changed images need transfer. Selection of a set of files may include both items shown in the main WIP window 2601 and items chosen from the supplementary material: by default, when a main-window version is chosen for download, so is each of its associated supplementary items. If the system recognises a particular item as identical to an item earlier downloaded by the same user, our preferred embodiment inquires whether the user really wants to download it again.

In our preferred embodiment, which may be implemented for use with many browsers and operating systems by using the Web-based Distributed Authoring and Versioning (WebDAV) mechanism, a folder appearing on a web page can appear and act very similarly to an OS folder on the user's desktop. In particular, items can be dragged from the OmniPad window shown in FIG. 26 to the user's desktop or one of the user's folder. Timothy can then simply drag the currently selected files, as a set, to the local folder where he wishes to work with them, as if moving a group of items between local folders. WebDAV simplifies the user interaction but does not speed a download once started, so that the speed advantage of separate image storage persists for users with limited bandwidth.

Other mechanisms beside WebDAV can be used for this purpose, but they share its characteristic that the user must go though some OS-level steps of establishing the necessary connection. A user prepared to do this (and able to follow the instructions involved) will often be equally prepared to install a ‘thin client’ on the local machine, overriding malware warnings about executable files downloaded from the web, which permits the appearance of the window in FIG. 26 not within a web page but as a folder on the user's desktop or in the user's folder hierarchy. (It still does not give local speed to file transfer, creating some cognitive dissonance among the users who cannot yet distinguish the Windows Explorer folder interface from the Internet Explorer browser.) This is our preferred embodiment, where supported.

To maintain the distinction between the main version files and supplementary material, the user is able to drop files not into the window 2601 as a whole, but into one of the ‘entry ports’ 2660 or 2661, as appropriate.

Where WebDAV, remote mounting, etc., are blocked by protective firewalls or plain confusion installed by the technical staff of the user's institution, or the user resists setting up a remote transfer system of this type, clicking the button 2651 or 2653 opens the standard ‘browse the file hierarchy’ dialogue box of the OS by which the user can select a file to upload, or a folder into which to download a selected file. In our preferred embodiment the user is able to select transfer multiple files for which upload or download is simultaneously commanded by the ‘OK’, ‘Open’ or similar click, rather than repeat the dialogue and ‘OK’ for each file.

The button 2652 does something more than manage user choices in file transfer. The currently selected files in the window 2601 are assembled into a single file of a type determined by the user's current settings, which shows the best approximation to the change information displayed by OmniPad (opening with that set of files) that can be read and used with the editor preferred by the user. This may be a locally installed version of OmniPad, in which case the match will be close (subject to differences between the version on the web and one downloaded and not recently updated), or a default editor associated with the file type, or another editor specified in the user's preference settings. All settings may be reached, and modified by a standard dialogue box with explanatory text and options to click, via the button 2656.

The button 2655 leads to a dialogue by which the user may invite collaborators (identified by email addresses or by member IDs specific to the particular OmniPad site) to join the group working on a WIP; its use may be restricted to the Moderator of the WIP, if any. An invitee who is not already a member of the site may, in accepting the invitation, be required to go through a registration process and (depending on the embodiment and the work style chosen for the group) to mount connections or install a thin client for one of the file transfer mechanisms above. Alternatively, access may be arranged as disclosed in USPTO filing 60/891,534 “A Method and System for Invitational Recruitment to a Web Site” by the same inventors, referred to above.

### Administrative Tools

A member of an OmniPad web site has a home page on that site. A button on that page leads to a dialogue (not shown, being evident to any person skilled in the art) by which the member can create a new WIP, set whether it is Moderated, name a Moderator (by default the creator of the WIP, but not by definition), issue invitations to a initial collaborator list, pay any necessary fees, and so forth.

As well as the descent tree display in FIG. 26, a Working Group member can see a list of versions tabulated by co-author, with upload dates; in our preferred embodiment, descent links are also shown. As with the listing in FIG. 26, double clicking on a version opens a compressed view which shows where it differs from those version from which it has direct descent. Optionally, in Moderated mode the Moderator may set dates by which the next input from each collaborator is expected: in this case the list just mentioned will display these dates, and indicate whether they are close, or already past.

### Flow of a Representative Embodiment

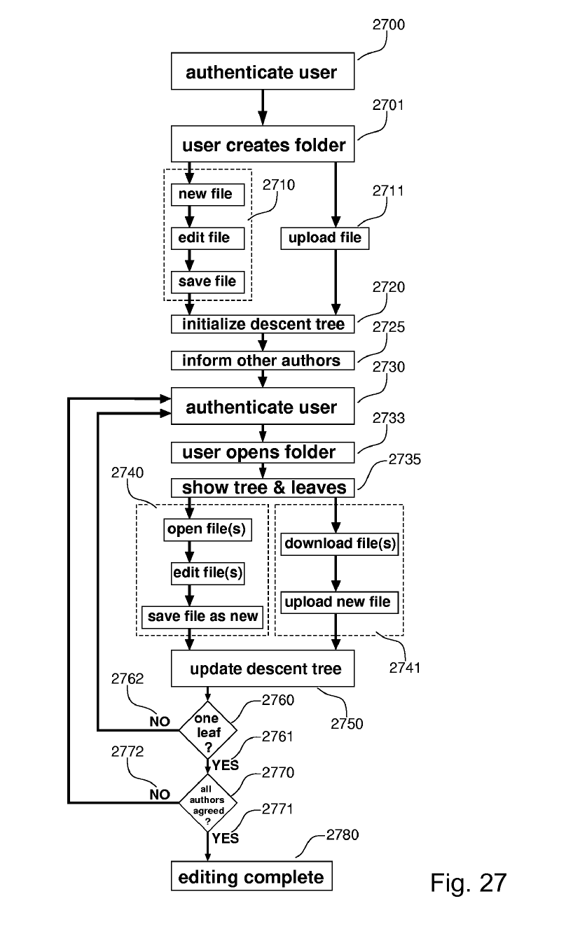

FIG. 27 shows an overview of an exemplary flow of the method, as in the web service variant of the invention, our preferred embodiment. It exhibits the process as ‘seen’ by the server, without the means that may be chosen for communication among users, or for activity on the user's local computer; many such means will be evident to one skilled in the art, within the spirit of the present invention.

At the beginning of a joint writing project, at least one user is assumed in FIG. 27 to have established membership of the site run by the server, with an identity, means to log in, and protection of data, by one or another means familiar to those skilled in the art. In the step 2700 this user logs in and confirms his or her identity with the server. The user then 2701 creates a project, typically visible as a folder (on a web page, or in a local desktop or folder display) to those interacting with it. Two sub-pathways are then typical, either or both of which may be supported by an embodiment of the present invention; by sub-path 2710 the user creates a new file on the server (preferably using a standard file opening menu, with the usual options for new or existing files, so that it appears to be created by the act of opening it), edits it using tools provided by the server. These tools include at least the usual functionality provided by word processing software (selection, deletion, cut and paste, insertion of new text, etc.), and in our preferred embodiment the means for variably compressed display, marking of repetitions, and various forms of comparison described above, in a single-window or multiple-window format, though in the first editing of an initial document there is not yet a point of application for tools that address a multiplicity of versions. By an alternative subpath, the user may simply upload 2711 a file created earlier, by some means whose not limited by the use of this invention except insofar as the embodiment recognizes only certain specific file formats. As already remarked, the user may upload several files at this point, if there has already been the creation of multiple versions: the necessary variations in what follows will be evident to those skilled in the art. Optionally, the user may repeat the pathway 2710 one or more additional times, creating, editing and saving additional files; or the user may within this pathway reopen a saved file, edit it further, and save it again. In this situation, where no other file has been created in the folder while the re-editing occurred, and where the same user is involved, the re-saved version may optionally be permitted to overwrite the previous version, or the other user may be offered the choice of whether to overwrite or to treat the new save as new version, increasing the number of visibly existing files in the folder.

After either pathway 2710 or 2711, the system intializes 2720 the data structure of the descent tree. For a single file this is trivial; if multiple files have already been created or uploaded, their descent must be decided in the manner described in detail above.

The user then causes the system to send 2725 information of the project's creation to other proposed authors, identified either by IDs within the embodiment of the present invention or by email addresses, and giving them an address by which they can access the folder created in step 2701. The system creates IDs as necessary for these invited collaborators, and records permission data for them to access the said folder.

The next step 2730 is user-driven, in that a particular user in the group of those with access privileges connects to the embodiment. In step 2730, the system verifies the user password or other means of authentication, and permits this user to open 2733 the folder displaying the project.

The opening display then 2735 shows the descent tree, in the manner of FIG. 1, FIG. 26, or other convenient graphical format apparent to one skilled in the art, making clear which files correspond to leaves of the tree and (optionally) which was the most recent version contributed by the current particular user. As discussed in connection with FIG. 26, or by such other means as will be evident to one skilled in the art, the user accepts or modifies this subset of files as a working set. These files may be dealt with according to pathway 2740, or according to pathway 2741; an embodiment may support either or both of these pathways. Our preferred embodiment supports both.

In case 2740 the system opens a single or multiple window display over the web for the user, showing the file or files opened in an integrated manner that permits editing and harmonizing as discussed (in particular) with reference to FIGS. 5 to 20 above. The user creates a new version using tools provided by the server. These tools include at least the usual functionality provided by word processing software (selection, deletion, cut and paste, insertion of new text, etc.), and in our preferred embodiment the means for variably compressed display, marking of repetitions, and various forms of comparison described above, in a single-window or multiple-window format. Optionally, the user may repeat the pathway 2740 one or more additional times, creating, editing and saving additional files; or the user may within this pathway reopen a saved file, edit it further, and save it again. In this situation, where no other file has been created in the folder while the re-editing occurred, and where the same user is involved, the re-saved version may optionally be permitted to overwrite the previous version, or the other user may be offered the choice of whether to overwrite or to treat the new save as new version, increasing the number of visibly existing files in the folder.

In case 2741 the user downloads either the selected set of versions as distinct files, or an integrated version created by the embodiment to be conveniently edited in a particular application or set of applications. Such an application may include a local embodiment of the present invention, using the structure of the integrated version to enable use of the tools specifically described above in relation to it, or may be word processing software existing independently of the present invention, in which case the presentation of variants, additions, deletions, etc., must be adapted to what is supported within that software. This pathway concludes with the uploading of a revision, which is stored as a new and separate version, without overwriting earlier versions.

When a new version has been saved by a user following pathway 2740 or 2741, the embodiment updates the descent tree, by string comparison as described above. This process may be optimized by various means evident to one skilled in the art, such as to record and associate with each version those substrings already identified as originating in that version. Search in the new file for the presence of the particular strings thus associated with leaves of the tree may provide all the direct descent information that a particular embodiment requires. Detailed comparison of the new version with at least each of the descent tree's leaves remains necessary for the editing process, if this version is chosen as working copy in a subsequent round of editing.

When the descent tree has been updated, the embodiment tests it 2760 for the presence of more than one leaf. If more than one leaf exists 2762, it is necessary for at least one user to return at least once to the authentication step 2730 or (not shown) if already authenticated to the opening step 2733, and proceeding through the path 2740 or 2741 to the update step 2750. If only one leaf exists 2761, it may be a final version. By contact between the authors (using methods outside the embodiment, or a variety of possible means within it that will be evident to one skilled in the art), this question is decided 2770. If 2772 a new revision is necessary, one or another author agrees to perform it. Otherwise 2771, a final version has been reached 2780, and may be published, transmitted to an intended recipient, or otherwise dealt with according to the needs of the authors.
The invention relates to a method for facilitating the production of documents when executed on a control unit of a computer unit, comprising the steps of assembling a related group of files on the computer; marking each file of the group with an identity; comparing the files of the group to find matching substrings; determining a file to be the original version based on the comparison; deriving a descent tree structure of the files of the group based on the comparison, starting from the determined original file; and displaying the group of files in the descent tree structure to a user on a display.

In an embodiment the step of determining the original version comprises the steps of: determining earliest occurrences of at least one substring; setting a file comprising the earliest unique substring as the original file.
In an embodiment the method further comprises a step of defining an extensible set of creators with access to the said group of files.
In an embodiment the step of marking each file comprises the steps of: attaching a creation date and time to each file; and/or attaching an identity of a creator to each file.

In an embodiment the method discloses wherein a first re-occurrence of a unique substring in a file is used as evidence of direct descent from the file comprising the unique substring originally.

In an embodiment the invention relates to a method and system for facilitating the production of documents, comprising the steps of assembling multiple versions of a document or related group of documents on a computer; defining an extensible set of creators with access to the said document or group; attaching a creation date and time to each version file; attaching a creator's identity to each version file; comparing version files pairwise to find exact or partial matches of substrings; finding earliest occurrences of unique substrings; deriving a descent tree for the version files present; displaying the said descent tree to a user.

In an embodiment access to the said document or group is via an internet or extranet, and the said collaborators are granted access to the said group of version files, said access being denied to non-collaborators, and including the power to view or download existing files and the power to upload or by editing create and save new files.

In an embodiment access to the said document or group is via an internet or extranet, and a founding member of the set of creators invites others to the said set by a means that causes the server to grant them access, said access being denied to non-collaborators, and including the power to view or download existing files and the power to upload or by editing create and save new files.

Furthermore may a founding member of the said set of creators at any time invite another user to the said set by a means that causes the server to grant the said user access, said access being denied to non-collaborators, and including the power to view or download existing files and the power to upload or by editing create and save new files.

In addition, an embodiment of the invention discloses where any member of the said set of creators can at any time invite another user to the said set by a means that causes the server to grant the said user access, said access being denied to non-collaborators, and including the power to view or download existing files and the power to upload or by editing create and save new files.

In addition, an embodiment of the invention discloses where one member of the said set of creators is distinguished as the Moderator of the said group.

Furthermore, an embodiment of the invention discloses where the said creation date is a date of saving.

Furthermore, an embodiment of the invention discloses where the said creation date is a date of saving, said date being preserved when the said version file is moved or copied without internal changes.

Furthermore, an embodiment of the invention discloses where the said creation date is a date of file upload to a server.

Furthermore, an embodiment of the invention discloses where the said identity is the log-in identity, on a shared access computer, of the user saving the said version file.

Furthermore, an embodiment of the invention discloses where the said identity is an identity used for access to the server on which the method and system is embodied, by the user uploading the said version file.

Furthermore, an embodiment of the invention discloses where the said comparison uses the Smith-Waterman algorithm or a derivative thereof.

Furthermore, an embodiment of the invention discloses where the first re-occurrence of a unique substring is used as evidence of direct descent.

Furthermore, an embodiment of the invention discloses where the said tree is displayed as a tree diagram.

Furthermore, an embodiment of the invention discloses where the said tree is displayed as a sequential list with direct descent links.

Furthermore, an embodiment of the invention discloses where the leaves of said tree are visually distinguished, optionally together with most recent version file created by the said user.

Furthermore, an embodiment of the invention discloses where the leaves of said tree are operationally distinguished, optionally together with most recent version file created by the said user, as a set of files that can be downloaded by the user with a single click or command.

Furthermore, an embodiment of the invention discloses where the set of files to be downloaded can be modified by clicking on the icons or names or other representatives of a file that is to be added to or excluded from the set.

Furthermore, an embodiment of the invention discloses where the said comparison is also used between each version file and itself.

Furthermore, an embodiment of the invention discloses where the leaves of said tree define a default set of version files to be shown to the user in an integrated display, minimizing repeated display of identical material.

Furthermore, an embodiment of the invention discloses where the said set may additionally include a working copy selected among non-leaf nodes of said tree.

Furthermore, an embodiment of the invention discloses where the user may add or remove members of the said set by clicking on elements of the display 1(h).

Furthermore, an embodiment of the invention discloses where a repetition revealed by the said self-comparison is displayed to the user as a possible error.

Furthermore, an embodiment of the invention discloses where each locus of mismatch among version files in a subset currently considered, as revealed by the said comparison, is displayed by software on the server or downloaded to the user's computer to the user as a set of alternate versions, optionally with the identity of a creator attached.

Furthermore, an embodiment of the invention discloses where the display shows the alternate versions as distinct but possibly overlapping changes relative to a version file selected as working copy.

Furthermore, an embodiment of the invention discloses where the default working copy is the most recent version file previously created by the user to whom the display is presented.

Furthermore, an embodiment of the invention discloses where the default working copy is the oldest file in the group.

Furthermore, an embodiment of the invention discloses where the default working copy is the most recent version file issued as a draft by the group's Moderator.

Furthermore, an embodiment of the invention discloses where the differences between an author's most recent version and the first version created by the Moderator that takes account of that version are listed and sent to that author, with any comments by the Moderator on reasons for their acceptance, rejection or modification.

Furthermore, an embodiment of the invention discloses where the working copy is selected by the current user.

Furthermore, an embodiment of the invention discloses where the members of the said set of creators may include a program module with natural language processing capability.

Furthermore, an embodiment of the invention discloses where the set of version files considered is a pair of files, one of the said files being judged to be descended from the other said file.

Furthermore, an embodiment of the invention discloses where the display distinguishes between deletions, insertions, rewrites and transpositions.

Furthermore, an embodiment of the invention discloses where deletions, insertions and rewrites are displayed within a transposed section of text, separately from the fact of the said section being transposed.

Furthermore, an embodiment of the invention discloses where said differences are shown to the user by marks connecting separate windows in which distinct version files are displayed.

Furthermore, an embodiment of the invention discloses where said repetitions are shown to the user in a single window.

Furthermore, an embodiment of the invention discloses where said repetitions are shown to the user by marks connecting separate windows in which distinct parts of a version file are displayed.

Furthermore, an embodiment of the invention discloses where said mismatches are shown to the user by marks at or connecting points within a single window showing an integrated view of multiple version files.

Furthermore, an embodiment of the invention discloses where variable compression allows widely separated repetitions to appear in said single window.

Furthermore, an embodiment of the invention discloses where variable compression allows the source and target locations of a transposition to appear in said single window.

Furthermore, an embodiment of the invention discloses where the said variable compression is modifiable by user input.

Furthermore, an embodiment of the invention discloses where the said variable compression is modifiable by user input.

Furthermore, an embodiment of the invention discloses where small differences are shown as inline substitutions.

Furthermore, an embodiment of the invention discloses where large differences are shown as contrasting boxes of text.

Furthermore, an embodiment of the invention discloses where each creator may add a comment, separate from the text, at any point in the text.

Furthermore, an embodiment of the invention discloses, where a creator can add to another's comment, such that a later access will show the sequence of additions with attached identities of the commenters.

Furthermore, an embodiment of the invention discloses where the Moderator may at any time issue an official draft of a document in the work in progress which by fiat has descent from all previous version files of that document.

Furthermore, an embodiment of the invention discloses where each locus of mismatch among version files in a subset currently considered, as revealed by the said comparison, is indicated to the user by a marker, optionally with the identity of a creator attached, such that clicking the said marker causes a full display of the said mismatch.

Furthermore, an embodiment of the invention discloses where the user may select, among the creators whose versions are in the subset currently considered, those for whom the said mismatches with the said working copy are to be displayed in full.

Furthermore, an embodiment of the invention discloses where the user may delete a particular marker from display.

Furthermore, an embodiment of the invention discloses where the user may in a single step delete all the markers indicating changes due to a particular creator from display.

Furthermore, an embodiment of the invention discloses where the said default set of files may be integrated for user download as a single file in which differences are indicated within the format conventions of an editor external to the embodiment of the present invention.

Furthermore, an embodiment of the invention discloses where the said repetition is marked in a downloadable file within the format conventions of an editor external to the embodiment of the present invention.

Furthermore, an embodiment of the invention discloses where the said subset set of files may be integrated for user download as a single file usable with editing software embodying the present invention that has been installed on the user's machine.

Furthermore, an embodiment of the invention discloses where the said subset set of files may be integrated for user download as a single file in which differences are indicated within the format conventions of an editor external to the embodiment of the present invention.

Furthermore, an embodiment of the invention discloses where the said subset set of files may be integrated for user download as a single file in which differences from the said working copy are indicated within the format conventions of an editor external to the embodiment of the present invention

Furthermore, an embodiment of the invention discloses where the existence of supplementary material associated with any particular version in the tree is indicated by an iconic mark.

Furthermore, an embodiment of the invention discloses where the existence of supplementary material associated with any particular version in the tree is indicated by an iconic mark.

Furthermore, an embodiment of the invention discloses where clicking the said iconic mark opens a list of the said supplementary material.

Furthermore, an embodiment of the invention discloses where clicking the said iconic mark opens a list of the said supplementary material.

Furthermore, an embodiment of the invention discloses where displays to the user are in a browser window.

Furthermore, an embodiment of the invention discloses where said browser window resembles a folder in the user's OS.

Furthermore, an embodiment of the invention discloses where displays to the user are in a window on the user's desktop, independent of a browser.

Furthermore, an embodiment of the invention discloses where a user may download a version or set of versions from the said group by dragging their icons to the user's desktop or a selected folder.

Furthermore, an embodiment of the invention discloses where a user may add a version or a set of versions or supplementary material to the said group by dragging their icons from the user's desktop or a selected folder.

Furthermore, an embodiment of the invention discloses where the said Moderator may attach deadlines to the next revision expected from individual co-authors.

Furthermore, an embodiment of the invention discloses where the display is structured to make each collaborator's versions clearly visible as a subset.

Furthermore, an embodiment of the invention discloses where each subset displays the said collaborator's relation to a current deadline.

Furthermore, an embodiment of the invention discloses where differences between the working copy and the current user's latest previous version are displayed, with any comments associated with non-acceptance by co-authors or the Moderator.

Furthermore, an embodiment of the invention discloses where the adoptions or rejections specifically of changes proposed in the current user's previous version are distinctively displayed.

Furthermore, an embodiment of the invention discloses where the full history of the adoption or rejection of changes proposed in all the current user's previous versions are distinctively displayed.

Furthermore, an embodiment of the invention discloses where the user may accept, reject or modify displayed differences, retain detected repetitions or delete one or more of the repeated segments, and modify any element of the text.

Furthermore, an embodiment of the invention discloses where the user may select a segment of text and perform a reverse-temporal sequential “undo” addressing only changes within the said segment, relative to a selected or default earlier version.

Furthermore, an embodiment of the invention discloses where the user may omit an “undo” in the reverse-temporal sequence and still proceed to undo previous steps which did not modify the same or overlapping text as was modified by the change whose omission is omitted.

Furthermore, an embodiment of the invention discloses where the user may scan the said segment of text, examine the changes shown, and click to select those to be retained or (according to preference) those to be undone.

Furthermore, an embodiment of the invention discloses where the user may with a single click undo all the changes in the said segment of text.
In addition, the invention relates to a computer program product comprising program instructions stored by a computer-readable medium for directing operations of a computer to perform the steps of: assembling a related group of files on the computer; marking each file of the group with an identity; comparing the files of the group to find matching substrings; determining a file to be the original version based on the comparison; deriving a descent tree structure of the files of the group based on the comparison, starting from the determined original file; and displaying the group of files in the descent tree structure to a user.

In an embodiment of the invention a computer program product may disclose a method that further comprises the step of determining the original version by performing the steps of: determining earliest occurrences of at least one substring; setting a file comprising the earliest unique substring as the original file.
An embodiment of the invention discloses a computer program product wherein the method further comprises a step of defining an extensible set of creators with access to the said group of files.
An embodiment of the invention discloses a computer program product where the members of the said set of creators may include a program module with natural language processing capability.
The invention further discloses a server comprising a control unit and a memory wherein a computer program product is stored in the memory arranged to perform a method when executed on the control unit comprising the steps of: assembling a related group of files on the computer; marking each file of the group with an identity; comparing the files of the group to find matching substrings; determining a file to be the original version based on the comparison; deriving a descent tree structure of the files of the group based on the comparison, starting from the determined original file; and displaying the group of files in the descent tree structure to a user in a web page format.

The foregoing has described the principles, preferred embodiments and modes of operation of the present invention. However, the invention should be regarded as illustrative rather than restrictive, and not as being limited to the particular embodiments discussed above. It should therefore be appreciated that variations may be made in those embodiments by those skilled in the art without departing from the scope of the present invention as defined by the following claims.

What is claimed is:

1. A method for facilitating the production of documents when executed on a control unit of a computer unit, comprising the steps of
assembling a related group of files on the computer;
marking each file of the group with an identity;
comparing the files of the group to find matching substrings;
determining a file to be the original version based on the comparison;
deriving a descent tree structure of the files of the group based on the comparison, starting from the determined original file; and
displaying the group of files in the descent tree structure to a user on a display.

2. A method according to claim 1, wherein the step of determining the original version comprises the steps of:
determining earliest occurrences of at least one substring;
setting a file comprising the earliest unique substring as the original file.

3. A method according to claim 1, wherein the method further comprises a step of defining an extensible set of creators with access to the said group of files.

4. A method according to claim 1, wherein the step of marking each file comprises the step of:
attaching a creation date and time to each file.

5. A method according to claim 1, wherein the step of marking each file comprises the step of:
attaching an identity of a creator to each file.

6. A method according to claim 1, wherein a first re-occurrence of a unique substring in a file is used as evidence of direct descent from the file comprising the unique substring originally.

7. A method according to claim 1, where leaves of the said tree, comprising those files without direct descendants, define a default set of version files to be shown to the user.

8. A method according to claim 1, where the said display minimizes repeated showing of identical material.

9. A method according to claim 7, where the said set of version files additionally includes a working copy selectable in the tree structure.

10. A method according to claim 1, where the display distinguishes between deletions, insertions, rewrites and transpositions.

11. A method according to claim 1, which enables a Moderator to issue an official draft of a document in the work in progress which by fiat has descent from all previous version files of that document.

12. A method according to claim 9, where the user selects, among multiple creators whose versions are in the subset currently displayed, those where differences with the said working copy are to be displayed in full.

13. A method according to claim 1, where the existence of supplementary material associated with any document in the tree is indicated by an interactive mark giving access to the said material.

14. A method according to claim 1, where a Moderator attaches deadlines to the next revision expected from individual co-authors.

15. A method according to claim 1, where the display is structured to make each collaborator's versions clearly visible as a subset.

16. A method according to claim 9, where differences between the working copy and the current user's latest previous version are displayed, with any comments associated with non-acceptance by co-authors or a Moderator.

17. A method according to claim 1, where adoptions or rejections specifically of changes proposed in the current user's previous version are distinctively displayed.

18. A method according to claim 17, where the user performs an action to accept, reject or modify displayed differences, retain detected repetitions or delete one or more of the repeated segments, and is able to modify any element of the text.

19. A method according to claim 18, where the user may select a segment of text and perform a reverse-temporal sequential “undo” addressing only changes within the said segment, relative to a selected or default earlier version.

20. A computer program product comprising program instructions stored by a computer-readable medium for directing operations of a computer to perform the steps of:
assembling a related group of files on the computer;
marking each file of the group with an identity;
comparing the files of the group to find matching substrings;
determining a file to be the original version based on the comparison;
deriving a descent tree structure of the files of the group based on the comparison, starting from the determined original file; and
displaying the group of files in the descent tree structure to a user.

21. A computer program product according to claim 20, wherein the method further comprises the step of determining the original version by performing the steps of:
determining earliest occurrences of at least one substring;
setting a file comprising the earliest unique substring as the original file.

22. A computer program product according to claim 20, wherein the method further comprises a step of defining an extensible set of creators with access to the said group of files.

23. A computer program product according to claim 19, where the members of the said set of creators may include a program module with natural language processing capability.

24. A server comprising a control unit and a memory wherein a computer program product is stored in the memory arranged to perform a method when executed on the control unit comprising the steps of:
assembling a related group of files on the computer;
marking each file of the group with an identity;
comparing the files of the group to find matching substrings;
determining a file to be the original version based on the comparison;
deriving a descent tree structure of the files of the group based on the comparison, starting from the determined original file; and
displaying the group of files in the descent tree structure to a user in a web page format.
